(19) United States
(12) Patent Application Publication
(10) Pub. No.: US 2025/0026663 A1
(43) Pub. Date: Jan. 23, 2025

(54) POSITIVE ELECTRODE ACTIVE MATERIAL, PREPARATION METHOD THEREOF, POSITIVE ELECTRODE, RECHARGEABLE LITHIUM BATTERIES AND ALL-SOLID-STATE RECHARGEABLE BATTERIES

(71) Applicant: SAMSUNG SDI CO., LTD., Yongin-si (KR)

(72) Inventors: Pilsang Yun, Yongin-si (KR); Saehwan Kim, Yongin-si (KR); Do-Yu Kim, Yongin-si (KR); Yasutaka Kamata, Yongin-si (KR); Pilgyu Byeon, Yongin-si (KR)

(21) Appl. No.: 18/766,791

(22) Filed: Jul. 9, 2024

(30) Foreign Application Priority Data
Jul. 21, 2023 (KR) 10-2023-0095517

(51) Int. Cl. C01G 53/00; H01M 10/0525

(52) U.S. Cl. CPC C01G 53/50; H01M 10/0525; C01P 2002/04; C01P 2004/61; C01P 2004/86; C01P 2006/40

(57) ABSTRACT

A positive electrode active material, including a first positive electrode active material including secondary particles including a lithium nickel-cobalt-aluminum composite oxide, wherein the secondary particles include an agglomeration of a plurality of primary particles and at least a portion of the plurality of primary particles are oriented radially, and a coating layer on a surface of the secondary particles, the coating layer including ZrO₂ and Li₆Zr₂O₇; and a second positive electrode active material including secondary particles including a lithium nickel-cobalt-aluminum-manganese composite oxide, wherein the secondary particles include an agglomeration of a plurality of primary particles, and a coating layer on a surface of the secondary particles, the coating layer including ZrO₂ and Li₆Zr₂O₇, wherein an average particle diameter of the secondary particles of the first positive electrode active material is larger than an average particle diameter of the secondary particles of the second positive electrode active material.

### CROSS-REFERENCE TO RELATED APPLICATION

This application claims priority to and the benefit of Korean Patent Application No. 10-2023-0095517 filed in the Korean Intellectual Property Office on Jul. 21, 2023, the entire contents of which are incorporated herein by reference.

### BACKGROUND

### 1. Field

Embodiments relate to positive electrode active materials, preparation methods

thereof, positive electrodes, rechargeable lithium batteries, and all-solid-state rechargeable batteries.

### 2. Description of the Related Art

A portable information device such as a cell phone, a laptop, smart phone, and the like or an electric vehicle has used a rechargeable lithium battery having high energy density and easy portability as a driving power source. Recently, research has been actively conducted to use a rechargeable lithium battery with high energy density as a driving power source or power storage power source for hybrid or electric vehicles.

### SUMMARY

Embodiments are directed to a positive electrode active material, including a

first positive electrode active material including secondary particles including a lithium nickel-cobalt-aluminum composite oxide, wherein the secondary particles include an agglomeration of a plurality of primary particles and at least a portion of the plurality of primary particles are oriented radially, and a coating layer on a surface of the secondary particles, the coating layer including ZrO₂ and Li₆Zr₂O₇; and a second positive electrode active material including secondary particles including a lithium nickel-cobalt-aluminum-manganese composite oxide, wherein the secondary particles include an agglomeration of a plurality of primary particles, and a coating layer on a surface of the secondary particles, the coating layer including ZrO₂ and Li₆Zr₂O₇, wherein an average particle diameter of the secondary particles of the first positive electrode active material is larger than an average particle diameter of the secondary particles of the second positive electrode active material. The average particle diameter of the secondary particles of the first positive electrode active material may be about 9 μm to about 25 μm, and the average particle diameter of the secondary particles of the second positive electrode active material may be about 2 μm to about 8 μm.

Based on a total weight of the first positive electrode active material and the second positive electrode active material, the first positive electrode active material may be included in an amount of about 60 wt % to about 95 wt %, and the second positive electrode active material may be included in an amount of about 5 wt % to about 40 wt %.

The coating layer of the first positive electrode active material and the coating layer of the second positive electrode active material may include a ZrO₂ crystalline phase, a Li₆Zr₂O₇ crystalline phase, and a Zr-containing amorphous region, respectively.

The coating layer of the first positive electrode active material and the coating layer of the second positive electrode active material may be in a form of a continuous film or in a form of an island.

A thickness of each of the coating layer of the first positive electrode active material and the coating layer of the second positive electrode active material may be about 5 nm to about 300 nm.

A total Zr content of the coating layer of the first positive electrode active material and the coating layer of the second positive electrode active material may be about 0.1 parts by mole to about 0.6 parts by mole, based on 100 parts by mole of total metal excluding lithium in the lithium nickel-cobalt-aluminum composite oxide of the first positive electrode active material and the lithium nickel-cobalt-aluminum-manganese composite oxide of the second positive electrode active material.

A total Zr content of the coating layer of the first positive electrode active material and the coating layer of the second positive electrode active material may be about 0.1 wt % to about 6 wt %, based on a total weight of the positive electrode active material.

The lithium nickel-cobalt-aluminum composite oxide of the first positive

electrode active material may be represented by Chemical Formula 1:

[Chemical Formula 1]

Liₐ₁Niₓ₁Co_{y1}Al_{z1}M¹_{w1}O_{2-b1}X_{b1}

wherein, in Chemical Formula 1, 0.9≤a1≤1.2, 0.7≤x1<1, 0<y1<0.3, 0<z1<0.3, 0≤w1<0.3, 0.9≤x1+y1+z1+w1≤1.1, 0≤b1≤0.1, M¹ may be B, Ba, Ca, Ce, Cr, Cu, Fe, Mg, Mo, Nb, Si, Sr, Sn, Ti, V, W, or Zr, and X may be F, P, or S.

The average particle diameter of the plurality of primary particles constituting the secondary particles of the first positive electrode active material may be less than about 200 nm.

The secondary particle of the first positive electrode active material may include an internal portion having an irregular porous structure and an external portion having a radially oriented structure as a region surrounding the internal portion.

At least a portion of the plurality of primary particles constituting the secondary particles in the first positive electrode active material may have a plate shape, and the secondary particles may include open pores on the surface, and the open pores may be formed by a space between plate-shaped primary particles oriented radially and the pores may be connected from the surface of the secondary particle toward a center.

The lithium nickel-cobalt-aluminum-manganese composite oxide of the second positive electrode active material may be represented by Chemical Formula 2:

[Chemical Formula 2]

Liₐ₂Niₓ₂Co_{y2}Al_{z2}Mn_{w2}M²ᵥ₂O_{2-b2}X_{b2}

wherein, in Chemical Formula 2, 0.9≤a2≤1.2, 0.7≤x2<1, 0<y2<0.3, 0<z2<0.3, 0<w2<0.3, 0≤v2<0.3, 0.9≤x2+y2+z2+w2+v2≤1.1, 0≤b2≤0.1, M² may be B, Ba, Ca, Ce, Cr, Cu, Fe, Mg, Mo, Nb, Si, Sr, Sn, Ti, V, W, or Zr, and X may be F, P, or S.

The second positive electrode active material may have a higher aluminum content in a surface layer of the secondary particles than the aluminum content in an internal portion of the secondary particles, and the internal portion may be a region from a center of the secondary particle to about 70 length % of a radius of the secondary particle, and the surface layer may be a region surrounding the internal portion and may be a region from an outermost surface of the secondary particle to a depth corresponding to about 30 length % of the radius of the secondary particle.

An Al content in the surface layer of the secondary particles of the second positive electrode active material may be about 0.2 at % to about 2.0 at %, based on 100 at % of total metal excluding lithium in the second positive electrode active material, and an Al content in the internal portion of the secondary particles of the second positive electrode active material may be about 0 at % to about 0.6 at %, based on 100 at % of total metal excluding lithium in the second positive electrode active material.

The surface layer of the secondary particles of the second positive electrode active material may include a high-concentration Al region and a low-concentration Al region, an Al content in the high-concentration Al region may be about 0.8 at % to about 2.0 at %, based on 100 at % of total metal excluding lithium in the second positive electrode active material, and an Al content in the low-concentration Al region may be less than about 0.8 at %, based on 100 at % of total metal excluding lithium in the second positive electrode active material.

A difference between the Al content in the high-concentration Al region and the Al content in the low-concentration Al region may be about 0.3 at % to about 2.0 at %.

Embodiments are directed to a method of preparing a positive electrode active material, the method including forming a first mixture by mixing a first positive electrode active material precursor including secondary particles including a nickel-cobalt-aluminum composite hydroxide, wherein the secondary particles are formed by agglomerating a plurality of primary particles and at least a portion of the primary particles is oriented radially, with a second positive electrode active material precursor including secondary particles including a nickel-cobalt-manganese composite hydroxide, wherein the secondary particles are formed by agglomerating a plurality of primary particles, and a lithium raw material; performing a first heat treatment on the first mixture to obtain a preliminary positive electrode active material, wherein an average particle diameter of the first positive electrode active material precursor is larger than an average particle diameter of the second positive electrode active material precursor; forming a second mixture by dry mixing the preliminary positive electrode active material and a zirconium raw material; and performing a second heat treatment on the second mixture to obtain a final positive electrode active material.

The nickel-cobalt-aluminum composite hydroxide of the first positive electrode active material precursor may be represented by Chemical Formula 11, and the nickel-cobalt-manganese composite hydroxide of the second positive electrode active material precursor may be represented by Chemical Formula 12:

[Chemical Formula 11]

Niₓ₁₁Co_{y11}Al_{z11}M¹¹_{w11}(OH)₂

wherein in Chemical Formula 11, 0.7≤x11<1, 0<y11<0.3, 0<z11<0.3, 0≤w11<0.3, 0.9≤x11+y11+z11+w11≤1.1, and M¹¹ may be B, Ba, Ca, Ce, Cr, Cu, Fe, Mg, Mo, Nb, Si, Sn, Sr, Ti, V, W, or Z,

[Chemical Formula 12]

Niₓ₁₂Co_{y12}Mn_{w12}M¹²ᵥ₁₂(OH)₂

wherein, in Chemical Formula 12, 0.7≤x12<1, 0<y12<0.3, 0<w12<0.3, 0≤v12<0.3, 0.9≤x12+y12+w12+v12≤1.1, and M¹² may be B, Ba, Ca, Ce, Cr, Cu, Fe, Mg, Mo, Nb, Si, Sr, Sn, Ti, V, W, or Zr.

An average particle diameter of the secondary particles of the first positive electrode active material precursor may be about 9 μm to about 25 μm, and an average particle diameter of the secondary particles of the second positive electrode active material precursor may be about 2 μm to about 8 μm.

A mixing weight ratio of the first positive electrode active material precursor and the second positive electrode active material precursor may be about 60:40 to about 95:5.

The first heat treatment may be performed at about 600° C. to about 1,000° C.

The zirconium raw material may be mixed in an amount of about 0.1 parts by mole to about 0.6 parts by mole based on 100 parts by mole of total metal excluding lithium in the preliminary active material.

The zirconium raw material may include a plurality of particles including zirconium oxide, and an average particle diameter (D₅₀) of the plurality of particles may be about 10 nm to about 500 nm.

The second heat treatment may be performed under an oxygen atmosphere at a temperature range of about 420° C. to about 580° C. for about 5 hours to about 25 hours.

The lithium raw material may be additionally mixed in the second mixture in an amount greater than about 1 part by mole and less than or equal to about 4 parts by mole based on 1 part by mole of the zirconium raw material.

Some embodiments provide a positive electrode including the positive electrode active material.

The positive electrode may further include a sulfide solid electrolyte.

Some embodiments provide a rechargeable lithium battery, including the positive electrode; a negative electrode; a separator between the positive electrode and the negative electrode; and a non-aqueous electrolyte.

Some embodiments provide an all-solid-state rechargeable battery, including the positive electrode; a negative electrode; and a solid electrolyte layer between the positive electrode and the negative electrode.

### BRIEF DESCRIPTION OF THE DRAWINGS

Features will become apparent to those of skill in the art by describing in detail exemplary embodiments with reference to the attached drawings in which:

FIG. 1 is a schematic view showing the shape of a plate-shaped primary particle according to an embodiment;

FIG. 2 is a view for explaining the definition of a radial in secondary particles according to an embodiment;

FIG. 3 is a schematic view showing a cross-sectional structure of a secondary particle according to an embodiment;

FIG. 4 is a schematic view illustrating a rechargeable lithium battery according to an embodiment;

FIGS. 5 and 6 are cross-sectional views schematically showing an all-solid-state rechargeable battery according to some embodiments;

FIG. 7 is a graph showing the initial charge capacity (left bar graph) and initial discharge capacity (right bar graph) for the all-solid-state rechargeable battery cells of Example 1 and Comparative Examples 1 to 5;

FIG. 8 is a graph showing the initial discharge capacity (bar graph, left vertical axis) and the capacity retention rate (dotted line graph, right vertical axis), which is the ratio of the 100th discharge capacity to the initial discharge capacity, for the all-solid-state rechargeable battery cells of Example 1 and Comparative Examples 1 to 5;

FIG. 9 is a cycle-life evaluation graph showing the capacity retention rate according to the number of cycles for the all-solid-state rechargeable battery cells of Example 1 and Comparative Examples 1 to 5;

FIG. 10 is a high-resolution transmission electron microscopy (HRTEM; left) and fast Fourier transform (inverse-FFT; right) image of a cross-section of Example 1;

FIG. 11 is an HRTEM image of the cross section of a small particle in Example 1; and

FIG. 12 is an inverse-FFT (left) and FFT rotation pattern (right) image for the portion indicated by a square in FIG. 11.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The terminology used herein is used to describe embodiments only, and is not intended to limit the present invention. The singular expression includes the plural expression unless the context clearly dictates otherwise.

As used herein, “combination thereof” means a mixture, laminate, composite, copolymer, alloy, blend, reaction product, and the like of the constituents.

Herein, it should be understood that terms such as “comprises,” “includes,” or “have” are intended to designate the presence of an embodied feature, number, step, element, or a combination thereof, but do not preclude the possibility of the presence or addition of one or more other features, number, step, element, or a combination thereof.

In addition, “layer” herein includes not only a shape formed on the whole surface when viewed from a plan view, but also a shape formed on a partial surface.

In addition, the average particle diameter may be measured by a suitable method, for example, may be measured by a particle size analyzer, or may be measured by a transmission electron microscopic image or a scanning electron microscopic image. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D₅₀) of particles having a cumulative volume of 50 volume % in the particle size distribution. As used herein, when a definition is not otherwise provided, the average particle diameter means a diameter (D₅₀) of particles having a cumulative volume of 50 volume % in the particle size distribution that is obtained by measuring the size (diameter or length of the long axis) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

### Positive Electrode Active Material

The positive electrode active material for a rechargeable lithium battery according to some embodiments may include a first positive electrode active material and a second positive electrode active material. The first positive electrode active material may have a form of a secondary particle including a lithium nickel-cobalt-aluminum composite oxide, in which a plurality of primary particles may be agglomerated, and at least a portion of the primary particles may be oriented radially, and may include a coating layer on the surface of the secondary particles and including ZrO₂ and Li₆Zr₂O₇. The second positive electrode active material may have a form of a secondary particle including a lithium nickel-cobalt-aluminum-manganese composite oxide, in which a plurality of primary particles may be agglomerated, and may include a coating layer on the surface of the secondary particles and including ZrO₂ and Li₆Zr₂O₇.

Herein, an average particle diameter of the secondary particles of the first positive electrode active material may be larger than an average particle diameter of the secondary particles of the second positive electrode active material. The secondary particles of the first positive electrode active material may be expressed as large particles, and the secondary particles of the second positive electrode active material may be expressed as small particles. Herein, the average particle diameter is measured through a scanning electron microscope and may mean the diameter (D₅₀) of a particle with a cumulative volume of 50 volume % in the particle size distribution.

In the first positive electrode active material, the lithium nickel-cobalt-aluminum composite oxide may refer to an oxide including lithium, nickel, cobalt, and aluminum, and optionally may further include other elements, and may be expressed as Ni-Co-Al or NCA. In the second positive electrode active material, the lithium nickel-cobalt-aluminum-manganese composite oxide may refer to an oxide including lithium, nickel, cobalt, aluminum, and manganese and optionally may further include other elements, and may be expressed as Ni—Co—Al—Mn or NCAM. In the method for preparing a positive electrode active material to be described later, the nickel-cobalt-manganese hydroxide, which may be a precursor of the second positive electrode active material, may refer to a hydroxide including nickel, cobalt, and manganese and optionally other elements, and may be expressed as an Ni—Co—Mn precursor or an NCM precursor.

The positive electrode active material according to some embodiments may be prepared through a method of mixing an NCA precursor, which may be a first positive electrode active material precursor, and an NCM precursor, which may be a precursor of a second positive electrode active material, with a lithium raw material and co-firing them. In the co-firing process, an Al component of the first positive electrode active material precursor, which may be a large particle and may be in the form of radial secondary particles, may move or diffuse into the precursor of the second positive electrode active material, which may be a small particle and may be in the form of secondary particles, thereby converting the second positive electrode active material into NCAM. Conversely, an Mn component of the second positive electrode active material precursor may not diffuse into the first positive electrode active material precursor, and thus the first positive electrode active material may not become NCAM but may be maintained as NCA.

In the positive electrode active material prepared in this way, the second positive electrode active material may have a different shape and composition distribution from the case where the positive electrode active material may be simply prepared using the NCAM composition precursor, or the NCAM positive electrode active material that may be coated or doped with Al by post-treatment with Al raw material after preparing the NCM positive electrode active material, and may also have more excellent capacity and cycle-life characteristics than the aforementioned case.

In addition, the positive electrode active material prepared by the existing method of firing the first positive electrode active material precursor and the second positive electrode active material precursor separately and then mixing them rather than co-firing them may have a different shape and composition distribution from the positive electrode active material according to some embodiments, a volumetric capacity of the battery may be reduced due to low pellet density, there may be a problem of low cycle-life characteristics due to the different deterioration rates of large and small particles, and even if the structural stability is increased by separately doping or coating the second positive electrode active material with Al, there may be a problem of capacity decrease due to the addition of Al raw material.

### Coating Layer

Furthermore, in the positive electrode active material according to some embodiments, a coating layer may be formed on both large and small particles. The coating layer may be formed through a dry coating method. This coating layer may include a mixed phase of ZrO₂ and Li₆Zr₂O₇. The coating layer may include ZrO₂, which may have relatively high crystallinity, and Li₆Zr₂O₇, which may have a lower crystallinity. The presence or absence of ZrO₂ and Li₆Zr₂O₇ may be determined through, e.g., an inverse FFT or FFT rotation pattern of a HRTEM image. The coating layer including ZrO₂ and Li₆Zr₂O₇ may facilitate the movement of lithium ions on the surfaces of each of the first and second positive electrode active materials and improve the structural stability of the positive electrode active material. In an implementation, the interfacial resistance may be improved by lowering the reactivity with the solid electrolyte. Herein, the coating layer may be expressed as a buffer layer or a protective layer.

The coating layer may further include an amorphous region. In an implementation, the coating layer may include a ZrO₂ crystalline phase, a Li₆Zr₂O₇ crystalline phase, and a Zr-containing amorphous region. Such a coating layer may improve lithium ionic conductivity and may improve the cycle-life characteristics of the positive electrode active material while having a thin and uniform thickness.

The coating layer may be in a form of a continuous film or in a form of an island. The coating layer may be prepared by a dry coating method, which will be described later. In an implementation, the coating layer may be well formed with a uniform thickness on the surface of the positive electrode active material without agglomerating or existing only locally. In an implementation, the coating layer may exist in the form of a continuous and uniform film on the surface of the secondary particle. In this case, the capacity characteristics and cycle-life characteristics of the positive electrode active material may be further improved.

A thickness of the coating layer may be about 5 nm to about 300 nm, e.g., about 5 nm to about 200 nm, about 5 nm to about 100 nm, about 5 nm to about 80 nm, or about 10 nm to about 50 nm. If the coating layer has a thickness in the above ranges, electrochemical characteristics of the battery may be improved by suppressing the increase in resistance caused by the coating, effectively protecting the positive electrode active material, and improving ionic conductivity.

The coating layer according to some embodiments may not exist only locally or agglomerate on the surface of the secondary particles of the positive electrode active material and may be formed to have a uniform thickness. In an implementation, a standard deviation of the coating layer thickness may be less than or equal to about 10%, or less than or equal to about 5%, and may be less than or equal to about 100 nm, less than or equal to about 50 nm, or less than or equal to about 30 nm based on the diameter of the positive electrode active material.

A total Zr content of the coating layer of the first positive electrode active material and the coating layer of the second positive electrode active material may be about 0.1 parts by mole to about 0.6 parts by mole, e.g., about 0.1 parts by mole to about 0.5 parts by mole, or about 0.1 parts by mole to about 0.4 parts by mole based on 100parts by mole of total metal excluding lithium in the lithium nickel-cobalt-aluminum composite oxide of the first positive electrode active material and the lithium nickel-cobalt-aluminum-manganese composite oxide of the second positive electrode active material. In an implementation, parts by mole based on 100 parts by mole may refer to mole % based on 100 mole %.

In addition, the total Zr content of the coating layer of the first positive electrode active material and the coating layer of the second positive electrode active material may be about 0.1 wt % to about 6 wt %, e.g., about 0.5 wt % to about 6 wt %, or about 1 wt % to about 5.5 wt %, based on a total weight of the positive electrode active material. In an implementation, the total Zr content of the coating layer of the first positive electrode active material and the coating layer of the second positive electrode active material may be about 0.1 at % to about 10 at %, e.g., about 0.1 at % to about 8 at %, about 0.1 at % to about 7 at %, about 0.5 at % to about 6.5 at %, or about 1 at % to about 6 at %, based on 100 at % of the positive electrode active material.

If the total Zr content of the coating layer is in the above ranges, the coating layer may sufficiently protect the positive electrode active material, may not act as resistance, and may not agglomerate or exist only locally on the surface of the secondary particles and may exist in a uniform thickness, thereby effectively improving cycle-life characteristics without reducing the capacity of the positive electrode active material. If the Zr content is excessive, the coating layer may become thick and act as a resistance layer, which may reduce charging and discharging capacity of the battery. Conversely, if the Zr content is too low, the coating layer may not sufficiently act as a buffer, shortening cycle-life characteristics of the positive electrode active material may deteriorate.

Hereinafter, each of the first and second positive electrode active materials will be described in detail.

### First Positive Electrode Active Material

The lithium nickel-cobalt-aluminum composite oxide of the first positive electrode active material may be represented by Chemical Formula 1.

[Chemical Formula 1]

Liₐ₁Niₓ₁Co_{y1}Al_{z1}M¹_{w1}O_{2-b1}X_{b1}

In Chemical Formula 1, 0.9≤a1≤1.2, 0.7≤x1<1, 0<y1<0.3, 0<z1<0.3, 0≤w1<0.3, 0.9≤x1+y1+z1+w1≤1.1, and 0<b1<0.1, M¹ may be, e.g., B, Ba, Ca, Ce, Cr, Cu, Fe, Mg, Mo, Nb, Si, Sn, Sr, Ti, V, W, or Zr, and X may be, e.g., F, P, or S.

In Chemical Formula 1, e.g., 0.7≤x1<0.98, 0.01≤y1≤0.29, 0.01≤z1<0.29, 0≤w1≤0.28; 0.8≤x1≤0.98, 0.01≤y1≤0.19, 0.01≤z1≤0.19, 0≤w1<0.18; or 0.9≤x1≤0.98, 0.01≤y1≤0.09, 0.01≤z1≤0.09, 0≤w1≤0.08.

The first positive electrode active material may be in the form of secondary particles in which a plurality of primary particles may be agglomerated, and the secondary particles may have spherical, elliptical, polygonal, or irregular shapes. The first positive electrode active material may include large particles, and the average particle diameter of the secondary particles may be about 9 μm to about 25 μm, e.g., about 9 μm to about 20 μm, or about 10 μm to about 18 μm. Herein, the average particle diameter of the secondary particles may be obtained by selecting about 20 particles at random among the large particles in the SEM image of the positive electrode active material, measuring the particle diameter (diameter, long axis, or length of the long axis) to obtain the particle size distribution, and taking the diameter (D₅₀) of particles with a cumulative volume of 50 volume % as the average particle diameter in the particle size distribution.

The average particle diameter of the primary particles constituting the secondary particles of the first positive electrode active material may be less than about 200 nm, e.g., greater than or equal to about 50 nm and less than about 200 nm, greater than or equal to about 100 nm and less than about 200 nm, greater than or equal to about 50 nm and less than or equal to about 190 nm, or greater than or equal to about 50 nm and less than or equal to about 180 nm. If the average particle diameter of the primary particles is in above ranges, the lithium diffusion path may be shortened, thereby reducing resistance and improving charge/discharge efficiency. Herein, the average particle diameter of the primary particles refers to the size of the primary particles observed on the surface of the secondary particles and may be obtained by selecting about 20 primary particles from the SEM image of the surface of the secondary particles, measuring their particle diameter (diameter, long axis, or length of long axis), and then calculating the arithmetic mean thereof.

The first positive electrode active material may be characterized in that at least a portion of the primary particles constituting the secondary particles may be oriented radially. In this case, the diffusion of lithium may be increased, improving initial charging and discharging efficiency and securing high capacity. Uniform expansion and contraction may be possible during the intercalation and deintercalation process of lithium, thereby helping mitigate the problem of the positive electrode active material breaking during charging and discharging to improve cycle-life characteristics and safety of a battery. In addition, if the first positive electrode active material is in the form of secondary particles in which at least a portion of the primary particles may be oriented radially, in the method for preparing the positive electrode active material according to some embodiments, it may be advantageous for the Al component to diffuse from the precursor of the first positive electrode active material into the second positive electrode active material precursor, and as a result, a positive electrode active material with improved capacity characteristics, initial charge/discharge efficiency, and cycle-life characteristics may be prepared.

Hereinafter, the radial structure will be described in detail.

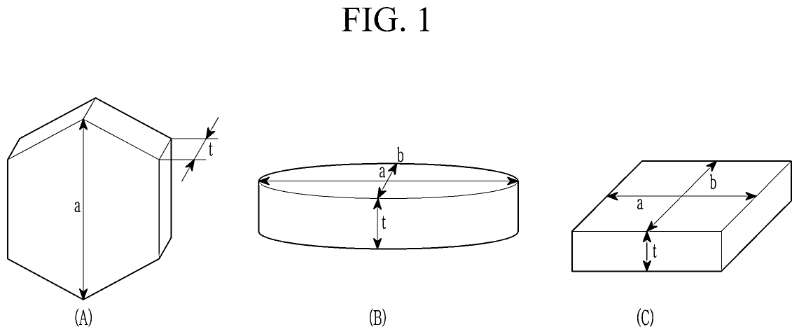

At least some of the primary particles may have a plate shape. FIG. 1 is a schematic view showing the plate shape of primary particles. Referring to FIG. 1, the primary particles may have various detailed shapes while having a basic plate structure, e.g., (A) a polygonal nanoplate shape such as a hexagon, (B) a nanodisk shape, and (C) a rectangular parallelepiped shape.

In FIG. 1, “a” means the length of the long axis of the primary particle, “b” means the length of the short axis, and “t” means the thickness. Herein, the length (a) of the long axis may mean a maximum length based on the widest surface of the primary particle. Thickness (t) may be a maximum length of the surface that may be approximately perpendicular to the widest surface of the primary particle. The direction including the length (a) of the long axis and the length (b) of the short axis may be defined as the plane direction, and the direction in which the thickness (t) may be defined as the thickness direction.

The thickness (t) of the primary particle may be smaller than the length (a) of the long axis and length (b) of the short axis, which may be the lengths in the plane direction. Among the lengths in the plane direction, the length (a) of the long axis may be longer or the same as the length (b) of the short axis.

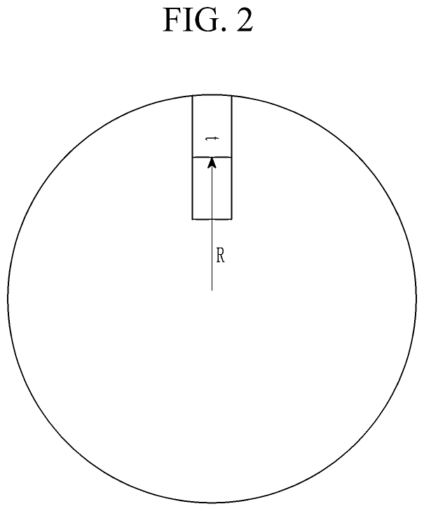

That the primary particles may be oriented radially may mean, e.g., that the long axis of the primary particles may be oriented in a radial direction. FIG. 2 is a view for explaining the definition of a radial. In an implementation, a radially oriented structure may mean that, as shown in FIG. 2, that the thickness (t) direction of the primary particles may be perpendicular to or within an angle of about ±5° of perpendicular to the direction (R) from the secondary particles from the center to the surface of the secondary particles.

In this case, if at least some of the primary particles are oriented radially, the surface of the secondary particles may have relatively many lithium diffusion passages between the primary particles, and many crystal planes capable of lithium transfer may be exposed to the outside, improving lithium diffusion and securing high initial efficiency and high capacity. Additionally, if the primary particles are oriented radially, the pores exposed on the surface of the secondary particle may be directed toward the center of the secondary particle, which may further promote the diffusion of lithium. In addition, the radially oriented primary particles may enable uniform expansion and contraction during intercalation and deintercalation of lithium, and pores may exist in the direction of the Miller index (001) plane, which may be the direction in which the particles expand if lithium is desorbed, which may act as a buffer. For example, pores between the primary particles in the direction of the Miller index (001) plane may help alleviate the volume change that may occur if lithium is desorbed. As a result, the probability of cracks occurring if the positive electrode active material contracts and expands may be lowered, and the internal pores may further alleviate volume changes, which may reduce cracks that occur between primary particles during charging and discharging, ultimately improving cycle-life characteristics of rechargeable lithium batteries and reducing the increase in resistance.

In an implementation, the secondary particle may include an internal portion having an irregular porous structure and an external portion having a radially oriented structure as a region surrounding the internal portion.

An irregular porous structure may mean that the structure may have primary particles and pores, but the pore size, shape, location, etc. may not be regular. In an implementation, the primary particles in the internal portion may be arranged without regularity, unlike the primary particles in the external portion. The radially oriented structure may mean a shape in which primary particles may be oriented radially. The term “external portion” may refer to a region within about 30 length % to about 50 length % from the outermost surface, e.g., within about 40 length % from the outermost surface with respect to a total distance from the center to the surface of the secondary particle, or in an implementation, may refer to a region within about 3 μm from the outermost surface of the secondary particle. The term “internal portion” may refer to a region within about 50 length % to about 70 length % from the center, e.g., within about 60 length % from the center with respect to a total distance from the center to the surface of the secondary particle, or in an implementation, a region excluding the region within about 3 μm from the outermost surface of the secondary particle.

Additionally, pores in the internal portion of the secondary particle may be larger than pores in the external portion of the secondary particle. In an implementation, the size of the pores in the internal portion may be about 150 nm to about 1 μm, and the size of the pores in the external portion may be less than about 150 nm. In this way, if the pore size in the internal portion is larger than that in the external portion, there may be an advantage in that the lithium diffusion distance inside the positive electrode active material may be shortened compared to secondary particles where the pore sizes in the internal and external portions may be the same, and intercalation of lithium from the external portion may be easy, it may have an effect of alleviating volume changes that occur during charging and discharging. Herein, the size of the pore means the diameter if the pore is spherical or circular, and the length of the long axis if the pore is oval. The size of the pores may be a value obtained by arbitrarily measuring the sizes of about 20 pores in an SEM image of the cross-section of a secondary particle and then calculating the arithmetic average thereof.

The secondary particles may have open pores on the surface. The open pore size may be less than about 150 nm, e.g., about 10 nm to about 148 nm. The open pore may be a pore in which some of the walls of the pore may not be closed, and may be formed by the space between radially oriented plate-shaped primary particles, and may be a pore deeply connected from the surface of the secondary particle toward the center. These open pores may be connected to the outside and may become passages through which substances can enter and exit the secondary particle. The open pores may be in the form of facing the center on the surface of the secondary particle, and may be formed to a depth of less than or equal to about 150 nm, e.g., about 0.001 nm to about 100 nm or about 1 nm to about 50 nm on average from the surface of the secondary particle. The size and depth of the open pores may be measured by the BJH (Barrett, Joyner and Halenda) method, which may be a method derived through the adsorption or desorption content of nitrogen.

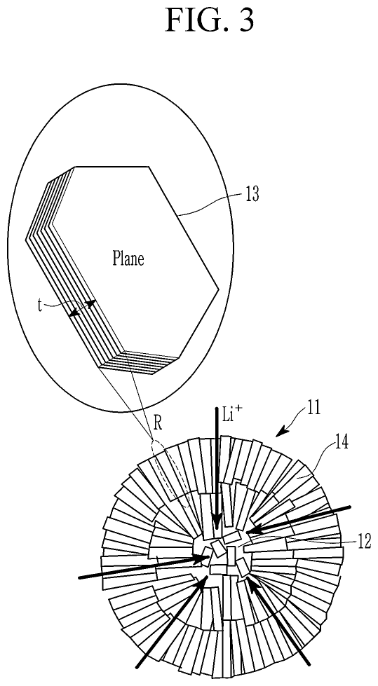

FIG. 3 is a schematic view showing the cross-sectional structure of secondary particle of positive electrode active material. Referring to FIG. 3, the secondary particle 11 has an external portion 14 where plate-shaped primary particles 13 are oriented in a radial direction, and an internal portion 12 where the primary particles 13 are irregularly oriented. The internal portion 12 may have more empty spaces between primary particles than the external portion. Additionally, the pore size and porosity in the internal portion 12 may be larger than those in the external portion, and the shape may be irregular. In FIG. 3, the arrow indicates the direction of movement of lithium ions.

The secondary particles may have a porous structure in the internal portion, which may have the effect of reducing the diffusion distance of lithium ions to the internal portion, and on the outside, the primary particles may be oriented radially, making it easy for lithium ions to be inserted into the surface. Additionally, the size of the primary particles may be small, making it easier to secure a lithium transfer path between crystal grains. Additionally, the size of the primary particles may be small and the pores between the primary particles may help alleviate the volume change that may occur during charging and discharging, thereby minimizing the stress caused by the volume change during charging and discharging. These positive electrode active materials may help reduce the resistance of rechargeable lithium batteries and improve capacity characteristics and cycle-life characteristics.

The first positive electrode active material may be included in an amount of about 60 wt % to about 95 wt %, e.g., about 70 wt % to about 90 wt %, based on a total weight of the positive electrode active material for a rechargeable lithium battery. If the first positive electrode active material is included within the above ranges, a positive electrode active material with an optimal composition may be prepared while increasing the pellet density of the positive electrode active material and the energy density of the positive electrode.

### Second Positive Electrode Active Material

The second positive electrode active material may be in the form of secondary particles in which a plurality of primary particles may be agglomerated, and may be a small particle, and the average particle diameter of the secondary particles may be about 2 μm to about 8 μm, e.g., about 2.5 μm to about 7 μm, or about 3 μm to about 6 μm.

The lithium nickel-cobalt-aluminum-manganese composite oxide of the second positive electrode active material may be represented by Chemical Formula 2.

[Chemical Formula 2]

Liₐ₂Niₓ₂Co_{y2}Al_{z2}Mn_{w2}M²ᵥ₂O_{2-b2}X_{b2}

In Chemical Formula 2, 0.9≤a2≤1.2, 0.7≤x2<1, 0<y2<0.3, 0<z2<0.3, 0<w2<0.3, 0≤v2<0.3, 0.9≤x2+y2+z2+w2+v2≤1.1, and 0≤b2≤0.1, M² is, e.g., B, Ba, Ca, Ce, Cr, Cu, Fe, Mg, Mo, Nb, Si, Sn, Sr, Ti, V, W, or Zr, and X is, e.g., F, P, or S.

In Chemical Formula 2, e.g., 0.7≤x2<0.979, 0.01≤y2<0.289, 0.001≤z2≤0.289, 0.01≤w2≤0.289, 0≤v2≤0.279; 0.8≤x2≤0.979, 0.01≤y2<0.189, 0.001≤z2≤0.189, 0.01≤w2<0.189, 0≤v230.179; or 0.95x2<0.979, 0.01≤y2≤0.089, 0.001≤z2≤0.089, 0.01≤w2≤0.089, 0≤v2≤0.079.

The second positive electrode active material may start as an NCM precursor and may become an NCAM composition by receiving an Al component from the first positive electrode active material during the firing process. As described above, the shape and composition distribution may be different from those in which the positive electrode active material was manufactured using the NCAM precursor.

In an implementation, the second positive electrode active material may have a higher aluminum content in the “surface layer of the secondary particle” than the aluminum content in the “internal portion of the secondary particle.”

The internal portion of the secondary particle may refer to a region from the center of the secondary particle to about 70 length % of the radius, and the surface layer of the secondary particle may refer to a region surrounding the internal portion, which may refer to refer to a region from the outermost surface of the secondary particle to a depth corresponding to 30% of the length of the radius. The outermost surface may refer to the surface of the secondary particle excluding the coating layer and may be understood as the boundary between the secondary particle and the coating layer. In other words, the secondary particles of the second positive electrode active material may include an internal portion, a surface layer surrounding the internal portion, and a coating layer on the surface layer. Both the internal portion and surface layer of secondary particles may be composed of a plurality of primary particles.

Hereinafter, an Al content in the internal portion or surface layer of the secondary particle may be measured through TEM-EELS (Transmission Electron Microscope-Electron Energy Loss Spectroscopy) analysis of a cross-section of the secondary particle cut with a focused ion beam (FIB). Additionally, the Al content may mean the at % content of aluminum based on 100 at % of total metal excluding lithium in the lithium nickel-cobalt-aluminum-manganese composite oxide.

In an implementation, the Al content in the surface layer of the secondary particle may be about 0.2 at % to about 2.0 at %, based on 100 at % of total metal excluding lithium in the second positive electrode active material, and the Al content in the internal portion of the secondary particle may be 0 at % to 0.6 at %, based on 100 at % of total metal excluding lithium in the second positive electrode active material, and the Al content in the surface layer may be higher than the Al content in the internal portion.

In addition, in the second positive electrode active material according to some embodiments, in the surface layer of the secondary particle, the aluminum content in the portion that may contact the first positive electrode active material during the primary heat treatment may be higher than the aluminum content in the portion that may not contact the first positive electrode active material. This may be understood to be because the second positive electrode active material may receive the Al component from the first positive electrode active material during the first heat treatment process, and it may also be a feature that distinguishes the second positive electrode active material from the case of using the NCAM precursor as small particles or the case of separately coating or doping Al.

In an implementation, in the surface layer of the secondary particles of the second positive electrode active material, the aluminum content based on a total metal excluding lithium in the portion in contact with the first positive electrode active material may be about 0.8 at % to about 2.0 at %, e.g., about 0.8 at % to about 1.8 at %, or about 0.9 at % to about 1.6 at %. The aluminum content based on a total metal excluding lithium in the portion not in contact with the first positive electrode active material may be less than about 0.8 at %, e.g., about 0 at % to about 0.7 at %, or about 0.1 at % to about 0.6 at %.

As another expression, it may be referred to that the second positive electrode active material according to some embodiments may include a high-concentration Al region and a low-concentration Al region in the surface layer of the secondary particle. In the high-concentration Al region, the aluminum content based on a total metal excluding lithium of the high-concentration Al region may be about 0.8 at % to about 2.0 at %, e.g., about 0.8 at % to about 1.8 at %, or about 0.9 at % to about 1.6 at %. In the low-concentration Al region, the aluminum content based on a total metal excluding lithium in the low-concentration Al region may be less than about 0.8 at %, e.g., about 0 at % to about 0.7 at %, or about 0.1 at % to about 0.6 at %.

Additionally, a difference between the aluminum content in the high-concentration Al region and the aluminum content in the low-concentration Al region may be about 0.3 at % to about 2.0 at %, e.g., about 0.4 at % to about 1.8 at %, or about 0.5 at % to about 1.5 at %.

After preparing a lithium transition metal composite oxide, doping or coating the lithium transition metal composite oxide with Al separately by mixing aluminum raw materials and heat treating them may be well known. However, in this case, unreacted Al raw material, e.g., aluminum oxide such as Al₂O₃, may remain in the final positive electrode active material, and as Al may be doped unevenly on the surface of the particle, a high concentration of Al doped at a level exceeding 2 at % may be created on some portions of the surface, which may cause the problem of reduced capacity. Unlike this, in the positive electrode active material according to some embodiments, no separate Al raw material may be added during the firing process, and therefore, in the final positive electrode active material, unreacted Al raw materials such as aluminum oxide may not exist on the outermost surfaces of the secondary particles of each of the first and second positive electrode active materials. In addition, even in a region with high Al content in the surface layer of the second positive electrode active material, the Al content may be less than or equal to about 2 at %, and the difference in Al content between the high-concentration Al area and the low-concentration Al area may also be small, at less than or equal to about 2 at %. Accordingly, the second positive electrode active material according to some embodiments may have structural stability and performance improvement effects due to Al doping, and problems such as capacity reduction caused by adding Al raw material during firing may be effectively suppressed.

The second positive electrode active material, which may be a small particle, may be included in an amount of about 5 wt % to about 40 wt %, e.g., about 10 wt % to about 30 wt %, based on a total weight of the positive electrode active material for a rechargeable lithium battery. If the second positive electrode active material is included in the above content range, a positive electrode active material with an optimal composition may be prepared while increasing the pellet density of the positive electrode active material and the energy density of the positive electrode.

Hereinafter, the method of preparing a positive electrode active material will be described in detail.

### Method of Preparing Positive Electrode Active Material

In some embodiments, a method of preparing a positive electrode active material may include (i) mixing a first positive electrode active material precursor including secondary particles including a nickel-cobalt-aluminum composite hydroxide, wherein the secondary particles may be formed by agglomerating a plurality of primary particles and at least a portion of the primary particles may be oriented radially; a second positive electrode active material precursor including secondary particles including a nickel-cobalt-manganese composite hydroxide, wherein the secondary particles may be formed by agglomerating a plurality of primary particles; and a lithium raw material and performing a first heat treatment to obtain a preliminary positive electrode active material, wherein an average particle diameter of the first positive electrode active material precursor may be larger than an average particle diameter of the second positive electrode active material precursor, and (ii) dry mixing the preliminary positive electrode active material and a zirconium raw material and performing a second heat treatment to obtain a final positive electrode active material.

The above preparing method may be a method of mixing large particle NCA radial secondary particle precursors and small particle NCM secondary particle precursors with the lithium raw material, co-firing them, and then coating them with zirconium in a dry manner. In the process of co-firing, the large particle Al component may diffuse or move into the small particles, making the small particles into the NCAM composition, and thus a positive electrode active material that may be a mixture of NCA of the large radial secondary particles and NCAM of the small secondary particles may be prepared. In the temperature range of co-firing, the diffusion rate of the Al component of the large particle may be faster than that of the Mn of the small particles, and the Al component may be more easily transferred to the small particles as the large particle precursor may have the form of radial secondary particles. The final positive electrode active material prepared in this way may exhibit high capacity, high initial charge/discharge efficiency, and excellent cycle-life characteristics.

According to the above preparing method, the volumetric capacity may be greatly improved compared to the existing method in which large and small particles may be individually fired and then mixed, and the initial discharge capacity, volumetric capacity, and energy density may be further improved compared to the case where only the small particles may be doped or coated with Al after individual firing and the small particles and large particles may be mixed. In addition, according to the method according to some embodiments, even if the co-firing method is applied, cycle-life characteristics may be improved compared to the case of using large and small particles having the same components, and initial discharge capacity and energy density may be improved compared to the case of separately doping or coating Al after co-firing. In the method of preparing a positive electrode active material according to some embodiments, an appropriate amount of aluminum may be introduced into the large and small particles without mixing aluminum raw materials during the first heat treatment and the second heat treatment, thereby ensuring structural stability, and improving capacity reduction problem which may be caused by the addition of aluminum raw materials.

The nickel-cobalt-aluminum composite hydroxide, which may be the first positive electrode active material precursor, may be represented by Chemical Formula 11

[Chemical Formula 11]

Niₓ₁₁Co_{y11}Al_{z11}M¹¹_{w11}(OH)2

In Chemical Formula 11, 0.7≤x11<1, 0<y11<0.3, 0<z11<0.3, 0≤w11<0.3, 0.9≤x11+y11+z11+w11≤1.1, and M¹¹ may be, e.g., B, Ba, Ca, Ce, Cr, Cu, Fe, Mg, Mo, Nb, Si, Sn, Sr, Ti, V, W, or Z.

The first positive electrode active material precursor may be made by

agglomerating a plurality of primary particles, and may be in the form of secondary particles in which at least a portion of the primary particles may be radially oriented. The average particle diameter of the secondary particles may be about 9 μm to about 25 μm, e.g., about 9 μm to about 20 μm, or about 10 μm to about 18 μm. Herein, the average particle diameter of the secondary particles may be obtained by selecting about 20 particles at random in the SEM image of the first positive electrode active material precursor, measuring the particle diameter (diameter, long axis, or length of the long axis) to obtain the particle size distribution, and taking the diameter (D₅₀) of particles with a cumulative volume of 50 volume % as the average particle diameter in the particle size distribution.

The first positive electrode active material precursor may be prepared through a co-precipitation reaction. In an implementation, a composite metal raw material may be prepared by mixing metal raw materials such as nickel raw materials, and a complexing agent and a pH controlling agent may be added thereto to proceed with the co-precipitation reaction while controlling the pH of the mixture to produce a nickel composite hydroxide of the desired composition. The complexing agent may play a role in controlling the reaction rate of precipitate formation in the co-precipitation reaction, and may be, e.g., ammonium hydroxide (NH₄OH) or citric acid. The pH controlling agent may be, e.g., sodium hydroxide (NaOH), sodium carbonate (Na₂CO₃), sodium oxalate (Na₂C₂O₄), or the like. The pH of the mixture may be, e.g., adjusted to range from about 10 to about 13.

The co-precipitation reaction may proceed in several steps, e.g., in 2 steps, 3 steps, or 4 steps. At each step, the concentration of the complexing agent, the input rates of the metal raw materials, the pH control range, reaction temperature, reaction time, or stirring power may be adjusted differently. Through this adjustment, it may be possible to prepare a positive electrode active material precursor in the form of secondary particles in which at least a portion of the primary particles may be radially oriented, and also to prepare secondary particles with different internal and external shapes.

In an implementation, the first positive electrode active material precursor having a radial structure may be manufactured by the following method. The method of preparing the first positive electrode active material precursor may include a first process, a second process, and a third process for forming a core, an intermediate layer, and a shell in that order. In the first process, the complexing agent, pH controlling agent, and metal raw materials may be added to the reactor and reacted. At this time, the concentration of the complexing agent may be about 0.1 M to about 0.7 M and the input amount may be about 6 mL/min to about 12 mL/min. The concentrations of the metal raw materials may be about 0.1 M to about 3.5 M and the input amounts thereof may be about 50 mL/min to about 100 mL/min. Subsequently, in the second process, the complexing agent, pH controlling agent, and metal raw materials may be further added. At this time, the concentration of the complexing agent may be about 0.3 M to about 1.0 M and the input amount thereof may be about 8 mL/min to about 15 mL/min. The concentrations of the metal raw materials may be about 0.1 M to about 3.5 M and the input amounts thereof may be about 60 mL/min to about 120 mL/min. Then, in the third process, the concentrations and input amounts of the complexing agent and metal raw material may be further increased or kept the same, so that the particle growth rate may not decrease. At this time, the concentration of the complexing agent may be about 0.35 M to about 1.0 M and the input amount thereof may be about 12 mL/min to about 20 mL/min. The concentration of the metal raw materials may be about 0.1 M to about 3.5 M and the input amounts thereof may be about 70 mL/min to about 150 mL/min. In the first to third processes, pH may be adjusted between about 10 and about 12.

The nickel-cobalt-manganese composite hydroxide, which may be a second positive electrode active material precursor, may be represented by Chemical Formula 12.

[Chemical Formula 12]

Niₓ₁₂CO_{y12}Mn_{w12}M¹²ᵥ12(OH)₂

In Chemical Formula 12, 0.7≤x12<1, 0<y12<0.3, 0<w12<0.3,0≤v12<0.3, 0.9≤x12+y12+w12+v12<1.1, and M¹² may be, e.g., B, Ba, Ca, Ce, Cr, Cu, Fe, Mg, Mo,

Nb, Si, Sn, Sr, Ti, V, W, or Zr.

The second positive electrode active material precursor may be in the form of secondary particles in which a plurality of primary particles may be agglomerated. The average particle diameter of the secondary particles may be about 2 μm to about 8 μm, e.g., about 2.5 μm to about 7 μm, or about 3 μm to about 6 μm. Herein, the average particle diameter of the secondary particles may be obtained by selecting about 20 particles at random among the large particles in the SEM image of the second positive electrode active material precursor, measuring the particle diameter (diameter, long axis, or length of the long axis) to obtain the particle size distribution, and taking the diameter (D₅₀) of particles with a cumulative volume of 50 volume % as the average particle diameter in the particle size distribution.

The second positive electrode active material precursor may be prepared through

a general co-precipitation reaction.

A mixing weight ratio of the first positive electrode active material precursor and the second positive electrode active material precursor may be about 60:40 to about 95:5, or about 70:30 to about 90:10.

The lithium raw material may be, e.g., Li₂CO₃, LiOH, hydrates thereof, or a combination thereof. The lithium raw material may be mixed in an amount of about 0.9 parts by mole to about 1.2 parts by mole based on 1 part by mole of the total metal in the first positive electrode active material precursor and the second positive electrode active material precursor.

The first heat treatment may be performed at, e.g., about 600° C. to about 1000° C., or about 700° C. to about 900° C. In the above temperature range, the first positive electrode active material and the second positive electrode active material may each have optimal composition.

In an implementation, the first heat treatment may include a temperature increase step and a temperature maintenance step, and the temperature increase time may be set to be longer than the temperature maintenance time. In an implementation, the temperature increase time may be about 6 to about 16 hours and the temperature maintenance time may be about 1 hour to about 9 hours, and the temperature increase time may be longer than the temperature maintenance time. In the first heat treatment, the temperature increase time may be, e.g., about 6 hours to about 15 hours, about 6 hours to about 14 hours, about 6 hours to about 13 hours, or about 7 hours to about 12 hours, and the temperature maintenance time may be, e.g., about 2 hours to about 9 hours, or about 3 to about 8 hours. Additionally, the ratio of (temperature increase time): (temperature maintenance time) may be about 1.1:1 to about 10:1, e.g., about 1.1:1 to about 8:1, about 1.1:1 to about 6:1, about 1.1:1 to about 5:1, or about 1.1:1 to about 4:1.

The preliminary positive electrode active material obtained through the first heat treatment may include a mixture of a preliminary first positive electrode active material in the form of secondary particles including a lithium nickel-cobalt-aluminum composite oxide represented by Chemical Formula 1 wherein the secondary particles may be formed by agglomerating a plurality of primary particles and at least a portion of the primary particles may be oriented radially and a preliminary second positive electrode active material in the form of secondary particles including a lithium nickel-cobalt-aluminum-manganese composite oxide represented by Chemical Formula 2 wherein the secondary particles may be formed by agglomerating a plurality of primary particles.

Some embodiments may provide a method of forming a zirconium-containing coating layer on both large and small particles by dry mixing a preliminary positive electrode active material and a zirconium raw material and performing a second heat treatment. The above method may be a dry coating method, and may not use organic solvents or expensive coating raw materials, and existing equipment may be used, making it economical, environmentally friendly, and enabling mass production. According to the above method, it may be possible to synthesize a positive electrode active material in which a coating layer including ZrO₂ and Li₆Zr₂O₇ may be formed on both large and small particles, and a coating layer with an appropriate content and thickness may be synthesized in a good form, thereby preparing positive electrode active materials having both improved capacity and cycle-life characteristics. In an implementation, these positive electrode active materials may have low reactivity with sulfide solid electrolyte particles and low interfacial resistance, so that they may be applied to all-solid-state rechargeable batteries, etc. to improve capacity characteristics, rate characteristics, and cycle-life characteristics.

The zirconium raw material may be a compound including the element zirconium that may be mixed in a dry manner. The zirconium raw material may be, e.g., zirconium-containing oxide, zirconium-containing sulfide, zirconium-containing carbonate, zirconium-containing hydroxide, etc., and may be, e.g., zirconium oxide, zirconium sulfide, zirconium carbonate, zirconium hydroxide, or a combination thereof.

The zirconium raw material may be mixed in an amount of about 0.1 parts by mole to about 0.6 parts by mole, e.g., about 0.1 parts by mole to about 0.5 parts by mole, or about 0.1 parts by mole to about 0.4 parts by mole, based on 100 parts by mole of total metal excluding lithium in the preliminary active material. If zirconium raw material is added in the above range, a coating layer of appropriate content and thickness may be formed, which may sufficiently protect the positive electrode active material, and may exist with a uniform thickness without agglomerating or existing only locally on the surface of the secondary particles. In an implementation, if the content of the zirconium raw material is excessive, the coating layer may become thick and act as a resistance layer, which may reduce the charge/discharge capacity of the positive electrode active material. Conversely, if the content of the zirconium raw material is too small, cycle-life characteristics of the positive electrode active material may be reduced because the coating layer may not sufficiently perform the buffer role.

In an implementation, the zirconium raw material may be in the form of nanoparticles. The zirconium raw material may be in the form of particles, and the average particle diameter (D50) of the particles may be, e.g., about 10 nm to about 500 nm, about 10 nm to about 500 nm, or about 50 nm to about 500 nm. In an implementation, the zirconium raw material may be particles including zirconium oxide, and the average particle diameter (D50) of the particles may be about 10 nm to about 500 nm. In this case, it may be advantageous to synthesize a coating layer of appropriate thickness.

In the method for preparing a positive electrode active material according to some embodiments, dry mixing may mean mixing without a solvent and may be understood as a solid-phase coating method. This may be distinct from wet coating or liquid coating.

In the method for preparing a positive electrode active material according to some embodiments, a coating layer including a mixed phase of ZrO₂ and Li₆Zr₂O₇ and having a uniform thickness may be formed by dry mixing followed by a second heat treatment. The heat treatment temperature may be about 420° C. to about 580° C., e.g., about 430° C. to about 570° C., about 440° C. to about 560° C., about 450° C. to about 550° C., or about 460° C. to about 530° C. By heat treatment in the above temperature range, it may be possible to synthesize a coating layer having an appropriate crystalline phase, and the coating layer may not act as a resistance layer but may sufficiently act as a buffer, thereby improving the capacity characteristics and cycle-life characteristics of the positive electrode active material. In an implementation, if the second heat treatment temperature is less than about 420° C., the coating layer may not form an appropriate crystalline phase and may only act as a resistance, which may deteriorate the capacity characteristics of the positive electrode active material. If the second heat treatment temperature exceeds about 580° C., the coating materials may be agglomerated or be coated only locally, reducing the effectiveness of the buffer. Additionally, zirconium may be absorbed into the positive electrode active material, failing to act as a buffer, and capacity and cycle-life characteristics may deteriorate.

The second heat treatment may be performed under an oxygen atmosphere, e.g., for about 5 hours to about 25 hours, or for about 10 hours to about 20 hours. Under these conditions, a good coating layer may be formed.

In some embodiments, if the preliminary positive electrode active material and the zirconium raw material are mixed in a dry manner, the lithium raw material may be mixed together. For example, lithium raw material may be mixed with the preliminary positive electrode active material and the zirconium raw material. The lithium raw material may be a compound including lithium that may be mixed in a dry manner. The lithium raw material may be, e.g., Li₂CO₃, LiOH, hydrates thereof, or a combination thereof. In some embodiments, anhydrous lithium hydroxide may be used as a lithium raw material. The lithium raw material may be mixed in an amount of more than about 1 part by mole and less than or equal to about 4 parts by mole, e.g., more than about 1 part by mole and less than or equal to about 3 parts by mole, or more than about 2 part by mole and less than or equal to about 4 parts by mole based on 1 part by mole of the zirconium raw material. If lithium raw materials are mixed together and heat treated, it may be advantageous to form a lithium zirconium oxide, e.g., Li₆Zr₂O₇ crystalline phase in the coating layer, may increase lithium ion conductivity, and obtain a coating layer of appropriate thickness in good form.

### Positive Electrode

In some embodiments, a positive electrode including the aforementioned positive electrode active material may be provided. The positive electrode may include a current collector and a positive electrode active material layer on the current collector, and the positive electrode active material layer may include the aforementioned positive electrode active material and may further include a binder or a conductive material.

The binder may improve binding properties of positive electrode active material particles with one another and with a current collector. Examples thereof may be, e.g., polyvinyl alcohol, carboxymethyl cellulose, hydroxypropyl cellulose, diacetyl cellulose, polyvinylchloride, carboxylated polyvinylchloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, or the like.

An amount of the binder may be about 0.1 wt % to about 5 wt %, or about 0.1 wt % to about 3 wt %, based on a total weight of the positive electrode active material layer.

The conductive material may be used to impart conductivity to the electrode, and any material that does not cause chemical change and conducts electrons may be used in the battery. Examples thereof may include a carbon material such as natural graphite, artificial graphite, carbon black, acetylene black, Ketjen black, a carbon fiber, a carbon nanofiber, carbon nanotube, or the like; a metal material including copper, nickel, aluminum, silver, etc. in a form of a metal powder or a metal fiber; a conductive polymer such as a polyphenylene derivative; or a mixture thereof.

An amount of the conductive material may be about 0.1 wt % to about 5 wt %, or about 0.1 wt % to about 3 wt %, based on a total weight of the positive electrode active material layer.

The positive electrode current collector may be an aluminum foil.

### Rechargeable Lithium Battery

Some embodiments may provide a rechargeable lithium battery including the aforementioned positive electrode active material. Herein, the rechargeable lithium battery may be understood as a general concept, such as a lithium ion battery using a non-aqueous electrolyte, a lithium metal battery using lithium metal as the negative electrode, and an all-solid-state rechargeable battery with a solid electrolyte layer between the positive and negative electrodes.

In some embodiments, a rechargeable lithium battery may include a positive electrode including the aforementioned positive electrode active material, a negative electrode, a separator between the positive electrode and the negative electrode, and a non-aqueous electrolyte.

In some embodiments, an all-solid-state rechargeable battery may include a positive electrode including the aforementioned positive electrode active material, a negative electrode, and a solid electrolyte layer between the positive electrode and the negative electrode.

### Lithium Ion Battery

In some embodiments, a lithium ion battery using a non-aqueous electrolyte as an electrolyte may be described as utilizing the aforementioned positive electrode active material.

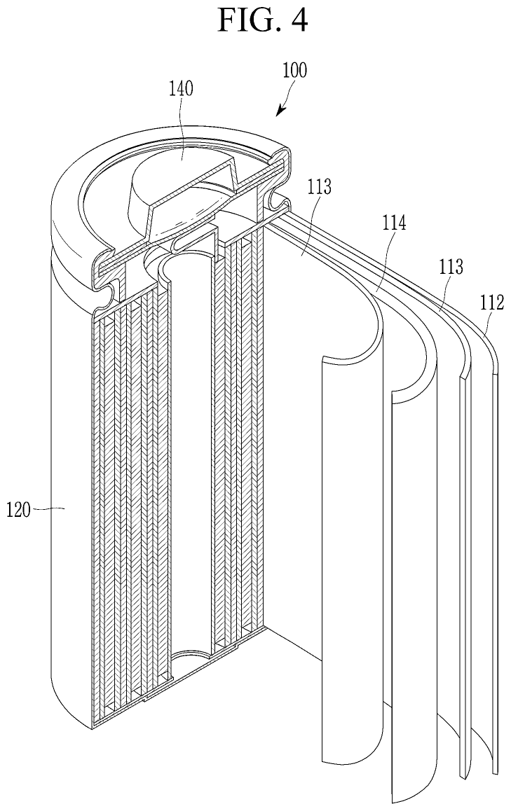

FIG. 4 is a schematic view illustrating a rechargeable lithium battery according to an embodiment. Referring to FIG. 4, a rechargeable lithium battery 100 according to an embodiment may include a battery cell including a positive electrode 114, a negative electrode 112 facing the positive electrode 114, a separator 113 between the positive electrode 114 and the negative electrode 112, and an electrolyte for a rechargeable lithium battery impregnating the positive electrode 114, negative electrode 112, and separator 113, a battery case 120 housing the battery cell, and a sealing member 140 sealing the battery case 120.

### Negative Electrode

The negative electrode for a rechargeable lithium battery may include a current collector, and a negative electrode active material layer on the current collector. The negative electrode active material layer may include a negative electrode active material, and may further include a binder or a conductive material.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, e.g., crystalline carbon, amorphous carbon, or a combination thereof as a carbon negative electrode active material. The crystalline carbon may be irregular, or sheet, flake, spherical, or fiber shaped natural graphite or artificial graphite. The amorphous carbon may be a soft carbon, a hard carbon, a mesophase pitch carbonization product, calcined coke, or the like.

The lithium metal alloy may include an alloy of lithium and a metal, e.g., Na, K, Rb, Cs, Fr, Be, Mg, Ca, Sr, Si, Sb, Pb, In, Zn, Ba, Ra, Ge, Al, or Sn.

The material capable of doping/dedoping lithium may be a Si negative electrode active material or a Sn negative electrode active material. The Si negative electrode active material may include, e.g., silicon, a silicon-carbon composite, SiOₓ (0<x<2), a Si-Q alloy (wherein Q may be, e.g., alkali metal, an alkaline-earth metal, a Group 13 element, a Group 14 element (excluding Si), a Group 15 element, a Group 16 element, a transition metal, a rare earth element, or a combination thereof), or a combination thereof. The Sn negative electrode active material may be Sn, SnO₂, a Sn alloy, or a combination thereof.

The silicon-carbon composite may be a composite of silicon and amorphous carbon. According to some embodiments, the silicon-carbon composite may be in the form of silicon particles and amorphous carbon coated on the surface of the silicon particles. In an implementation, it may include a secondary particle (core) in which silicon primary particles may be assembled and an amorphous carbon coating layer (shell) on the surface of the secondary particle. The amorphous carbon may also be present between the silicon primary particles, e.g., the silicon primary particles may be coated with amorphous carbon. The secondary particles may exist dispersed in an amorphous carbon matrix.

The silicon-carbon composite may further include crystalline carbon. In an implementation, the silicon-carbon composite may include a core including crystalline carbon and silicon particles and an amorphous carbon coating layer on the surface of the core.

The Si negative electrode active material or Sn negative electrode active material may be mixed with the carbon negative electrode active material.

In the negative electrode active material layer, the negative electrode active material may be included in an amount of about 95 wt % to about 99 wt %, based on a total weight of the negative electrode active material layer.

In some embodiments, the negative electrode active material layer may further include a binder, and may optionally further include a conductive material. The content of the binder in the negative electrode active material layer may be about 1 wt % to about 5 wt %, based on a total weight of the negative electrode active material layer. In addition, if the conductive material is further included, the negative electrode active material layer may include about 90 wt % to about 98 wt % of the negative electrode active material, about 1 wt % to about 5 wt % of the binder, and about 1 wt % to about 5 wt % of the conductive material based on a total weight of the negative electrode active material layer.

The binder may serve to well adhere the negative electrode active material particles to each other and also to adhere the negative electrode active material to the current collector. The binder may be a non-aqueous binder, an aqueous binder, a dry binder, or a combination thereof.

The non-aqueous binder may include, e.g., polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include, e.g., a styrene-butadiene rubber, a (meth)acrylated styrene-butadiene rubber, a (meth)acrylonitrile-butadiene rubber, a (meth)acrylic rubber, butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

If an aqueous binder is used as the negative electrode binder, a cellulose compound capable of imparting viscosity may be further included. As the cellulose compound, one or more of, e.g., carboxymethyl cellulose, hydroxypropyl methyl cellulose, methyl cellulose, or alkali metal salts thereof may be mixed and used. The alkali metal may be, e.g., Na, K, or Li.

The dry binder may be a polymer material capable of becoming fiber, and may be, e.g., polytetrafluoroethylene, polyvinylidene fluoride, a polyvinylidene fluoride-hexafluoropropylene copolymer, polyethylene oxide, or a combination thereof.

The conductive material may be included to provide electrode conductivity and any electrically conductive material may be used as a conductive material unless it causes a chemical change. Examples of the conductive material include a carbon material such as natural graphite, artificial graphite, carbon black, acetylene black, Ketjen black, a carbon fiber, a carbon nanofiber, a carbon nanotube, or the like; a metal material of a metal powder or a metal fiber including copper, nickel, aluminum silver, or the like; a conductive polymer such as a polyphenylene derivative; or a mixture thereof.

The negative electrode current collector may include, e.g., a copper foil, a nickel foil, a stainless steel foil, a titanium foil, a nickel foam, a copper foam, a polymer substrate coated with a conductive metal, or a combination thereof.

### Electrolyte

The electrolyte for a rechargeable lithium battery may include a non-aqueous organic solvent and a lithium salt.

The non-aqueous organic solvent may serve as a medium for transmitting ions taking part in the electrochemical reaction of a battery. The non-aqueous organic solvent may be a carbonate, ester, ether, ketone, or alcohol solvent, an aprotic solvent, or a combination thereof.

The carbonate solvent may include, e.g., dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. The ester solvent may include, e.g., methyl acetate, ethyl acetate, n-propyl acetate, dimethyl acetate, methyl propionate, ethyl propionate, decanolide, mevalonolactone, valerolactone, caprolactone, or the like. The ether solvent may include, e.g., dibutyl ether, tetraglyme, diglyme, dimethoxyethane, 2-methyltetrahydrofuran, 2,5-dimethyltetrahydrofuran, tetrahydrofuran, or the like. In addition, the ketone solvent may include, e.g., cyclohexanone, or the like. The alcohol solvent may include, e.g., ethanol, isopropyl alcohol, or the like and the aprotic solvent may include nitriles such as R-CN (wherein R may be, e.g., a C2 to C20 linear, branched, or cyclic hydrocarbon group, a double bond, an aromatic ring, or an ether bond, or the like); amides such as dimethylformamide; dioxolanes such as 1,3-dioxolane, 1,4-dioxolane, or the like; or sulfolanes, and the like.

The non-aqueous organic solvent may be used alone or as a mixture of two or more.

In addition, if using a carbonate solvent, a cyclic carbonate and a chain carbonate may be mixed and used, and the cyclic carbonate and the chain carbonate may be mixed in a volume ratio of about 1:1 to about 1:9.

The lithium salt dissolved in the organic solvent may supply lithium ions in a battery, enable a basic operation of a rechargeable lithium battery, and improve transportation of the lithium ions between positive and negative electrodes. Examples of the lithium salt may include, e.g., LiPF₆, LiBF₄, LiSbF₆, LiAsF₆, LiClO₄, LiAlO₂, LiAlCl₄, LiPO₂F₂, LiCl, LiI, LIN(SO₃C₂F₅)₂, Li(FSO₂)₂N (lithium bis(fluorosulfonyl)imide; LiFSI), LiC₄F₉SO₃, LIN(CₓF₂ₓ₊₁SO₂)(C_{y}F_{2y+1}SO₂), (wherein x and y may be integers of 1 to 20), lithium trifluoromethane sulfonate, lithium tetrafluoroethanesulfonate, lithium difluorobis)oxalato)phosphate (LiDFOB), and lithium bis(oxalato) borate (LiBOB).

### Separator

Depending on the type of the rechargeable lithium battery, a separator may be present between the positive electrode and the negative electrode. The separator may include, e.g., polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, or the like.

The separator may include a porous substrate and a coating layer including an organic material, an inorganic material, or a combination thereof on one or both surfaces of the porous substrate.

The porous substrate may be a polymer film formed of, e.g., polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, or polytetrafluoroethylene, or a copolymer or mixture of two or more thereof.

The organic material may include a polyvinylidene fluoride polymer or a (meth)acrylic polymer.

The inorganic material may include inorganic particles, e.g., Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

The organic material and the inorganic material may be mixed in one coating layer, or a coating layer including an organic material and a coating layer including an inorganic material may be stacked.

### All-Solid-State Rechargeable Battery

In one example, an all-solid-state rechargeable battery using the aforementioned positive electrode active material, using a solid electrolyte as an electrolyte, and interposing a solid electrolyte layer between the positive electrode and the negative electrode may be described.

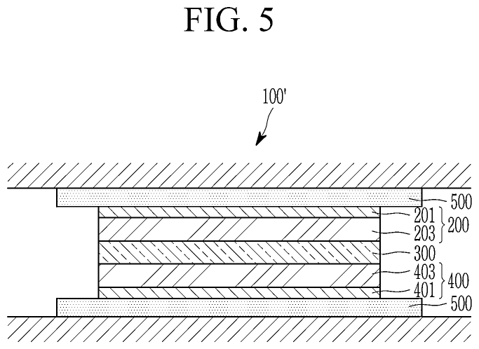

FIG. 5 is a cross-sectional view schematically illustrating an all-solid-state rechargeable battery according to some embodiments. Referring to FIG. 5, the all-solid-state rechargeable battery 100′ may have a structure that an electrode assembly, in which a negative electrode 400 including a negative current collector 401 and a negative electrode active material layer 403, a solid electrolyte layer 300, and a positive electrode 200 including a positive electrode active material layer 203 and a positive current collector 201 are stacked, may be housed in a battery case. The all-solid-state rechargeable battery 100′ may further include at least one elastic layer 500 on the outside of at least either one of the positive electrode 200 or the negative electrode 400. FIG. 5 shows one electrode assembly including the negative electrode 400, the solid electrolyte layer 300, and the positive electrode 200, but two or more electrode assemblies may be stacked to manufacture an all-solid-state rechargeable battery.

### Positive Electrode

The positive electrode for an all-solid-state rechargeable battery may include the aforementioned positive electrode active material and may optionally include a binder, a conductive material, or a solid electrolyte.

### Solid Electrolyte

The solid electrolyte may be an inorganic solid electrolyte such as a sulfide solid electrolyte, an oxide solid electrolyte, or a halide solid electrolyte.

In some embodiments, the solid electrolyte may be a sulfide solid electrolyte with excellent ionic conductivity. The sulfide solid electrolyte particles may include, e.g., Li₂S-P₂S₅, Li₂S-P₂S₅-LiX (wherein X may be a halogen element, e.g., I or Cl), Li₂S-P₂S₅-Li₂O, Li₂S-P₂S₅-Li₂O-LiI, Li₂S-SiS₂, Li₂S-SiS₂-LiI, Li₂S-SiS₂-LiBr, Li₂S-SiS₂-LiCl, Li₂S-SiS₂-B₂S₃-LiI, Li₂S-SiS₂-P₂S₅-LiI, Li₂S-B₂S₃, Li₂S-P₂S₅-ZₘSₙ (wherein m and n may each be an integer, respectively, and Z may be, e.g., Ge, Zn or Ga), Li₂S-GeS₂, Li₂S-SiS₂-Li₃PO₄, Li₂S-SiS₂-LiₚMO_{q} (wherein p and q may each be an integer, and M may be, e.g., P, Si, Ge, B, Al, Ga, or In), or a combination thereof.

Such a sulfide solid electrolyte may be obtained by, e.g., mixing Li₂S and P₂S₅ in a molar ratio of about 50:50 to about 90:10 or about 50:50 to about 80:20 and optionally performing heat-treatment. Within the above mixing ratio range, a sulfide solid electrolyte having excellent ionic conductivity may be prepared. The ionic conductivity may be further improved by adding SiS₂, GeS₂, B₂S₃, or the like as other components thereto.

Mechanical milling or a solution method may be applied as a mixing method of sulfur-containing raw materials for preparing a sulfide solid electrolyte. The mechanical milling may be to make starting materials into particulates by putting the starting materials in a ball mill reactor and vigorously stirring them. The solution method may be performed by mixing the starting materials in a solvent to obtain a solid electrolyte as a precipitate. In addition, in the case of heat-treatment after mixing, crystals of the solid electrolyte may be more robust and ionic conductivity may be improved. The heat treatment may be carried out at a temperature range of about 400° C. to about 600° C., e.g., about 450° C. to about 500° C., or about 460° C. to about 490° C., for about 5 hours to about 30 hours, about 10 hours to about 24 hours, or about 15 hours to about 20 hours. If heat treated under the above conditions, ionic conductivity may be maximized. In an implementation, the sulfide solid electrolyte may be prepared by mixing sulfur-containing raw materials and performing heat treatment two or more times. In this case, a sulfide solid electrolyte having high ionic conductivity and robustness may be prepared.

The sulfide solid electrolyte particles according to some embodiments, e.g., may be prepared through a first heat treatment of mixing sulfur-containing raw materials and firing at about 120° C. to about 350° C. and a second heat treatment of mixing the resultant of the first heat treatment and firing the same at about 350° C. to about 800° C. The first heat treatment and the second heat treatment may be performed under an inert gas or nitrogen atmosphere, respectively. The first heat treatment may be performed for about 1 hour to about 10 hours, and the second heat treatment may be performed for about 5 hours to about 20 hours. Small raw materials may be milled through the first heat treatment, and a final solid electrolyte may be synthesized through the second heat treatment. Through such two or more heat treatments, a sulfide solid electrolyte having high ionic conductivity and high performance may be obtained, and such a solid electrolyte may be suitable for mass production. The temperature of the first heat treatment may be, e.g., about 150° C. to about 330° C., or about 200° C. to about 300° C., and the temperature of the second heat treatment may be, e.g., about 380° C. to about 700° C., or about 400° C. to about 600° C.

In an implementation, the sulfide solid electrolyte particles may include argyrodite-type sulfide. The argyrodite-type sulfide solid electrolyte particles may have high ionic conductivity close to the range of about 10⁻⁴ to about 10⁻² S/cm, which may be the ionic conductivity of general liquid electrolytes at ambient temperature, and may form an intimate bond between the positive electrode active material and the solid electrolyte without causing a decrease in ionic conductivity, and furthermore, an intimate interface between the electrode layer and the solid electrolyte layer. An all-solid-state rechargeable battery including the same may have improved battery performance such as rate capability, coulombic efficiency, and cycle-life characteristics.

In an implementation, the argyrodite-type sulfide solid electrolyte particles may include a compound represented by Chemical Formula 21.

[Chemical Formula 21]

(LiₐM¹_{b}M²_{c})(P_{d}M³ₑ)(S_{f}M⁴_{g})Xₕ

In Chemical Formula 21, 4≤a≤8, M¹ may be, e.g., Mg, Ca, Cu, Ag, or a combination thereof, 0≤b<0.5, M² may be, e.g., Na, K, or a combination thereof, 0≤c<0.5, M³ may be, e.g., Sn, Zn, Si, Sb, Ge, or a combination thereof, 0<d<4, 0≤e<1, M⁴ may be, e.g., O, SOₙ, or a combination thereof, 1.5≤n≤5, 3≤f≤12, 0≤g<2, X may be F, Cl, Br, I, or a combination thereof, and 0≤h≤2.

In an implementation, in Chemical Formula 21, a halide element (X) may be necessarily included, and in this case, it may be expressed as 0<h≤2. In an implementation, the M¹ element may be necessarily included in Chemical Formula 21, and in this case, it may be expressed as 0<b<0.5. In Chemical Formula 21, M³ may be understood as an element substituted for P and may be 0<e<1. In Chemical Formula 21, M⁴ may be substituted for S and, e.g., may be 0<g<2, and f, a ratio of S, may be, e.g., 3≤f≤7. If M⁴ is SOₙ, SOₙ may be, e.g., S₄O₆, S₃O₆, S₂O₃, S₂O₄, S₂O₅, S₂O₆, S₂O₇, S₂O₈, SO₄, or SO₅, and, e.g., may be SO₄.

In an implementation, in Chemical Formula 21, a+b+c+h=7, d+e=1, and f+g+h=6.

In an implementation, the argyrodite-type sulfide solid electrolyte particles may include, e.g., Li₃PS₄, Li₇P₃S₁₁, Li₇PS₆, Li₆PS₅Cl, Li₆PS₅Br, Li_{5.8}PS_{4.8}Cl_{1.2,} Li_{6.2}PS_{5.2}Br_{0.8}, Li_{5.75}PS_{4.75}Cl_{1.25}, (Li_{5.69}Cu_{0.06})PS_{4.75}Cl_{1.25}, (Li_{5.72}Cu_{0.03}) PS_{4.75}Cl_{1.25}, (Li_{5.69}Cu_{0.06})P(S_{4.70} (SO₄)_{0.05})C_{11.25}, (Li_{5.69}Cu_{0.06})P(S_{4.60} (SO₄)_{0.15})C_{11.25}, (Li_{5.72}Cu_{0.03})P(S_{4.725} (SO₄)_{0.025})C_{11.25}, (Li_{5.72}Na_{0.03})P(S_{4.725}(SO₄)_{0.025})C_{11.25}, Li_{5.75}P(S_{4.725}(SO₄)_{0.025})C_{11.25,} or a combination thereof.

The argyrodite-type sulfide solid electrolyte may be prepared, e.g., by mixing lithium sulfide and phosphorus sulfide, and optionally lithium halide. Heat treatment may be performed after mixing them. The heat treatment may include, e.g., two or more heat treatment steps. The method of preparing the argyrodite-type sulfide solid electrolyte may include, e.g., a first heat treatment in which raw materials may be mixed and fired at about 120° C. to about 350° C., and a second heat treatment in which the resultant of the first heat treatment may be mixed again and fired at about 350° C. to about 800° C.

An average particle diameter (D₅₀) of the sulfide solid electrolyte particles may be, e.g., about 0.1 μm to about 5.0 μm, and may be small particles of about 0.1 μm to about 1.9 μm or large particles of about 2.0 μm to about 5.0 μm. The average particle diameter of the sulfide solid electrolyte particles may be measured using an electron microscope image, and, e.g., a particle size distribution may be obtained by measuring the size (diameter or long axis length) of about 20 particles in a scanning electron microscope image, and D₅₀ may be calculated therefrom.

The solid electrolyte may include an oxide inorganic solid electrolyte in addition to a sulfide material. The oxide inorganic solid electrolyte may include, e.g., Li₁₊ₓTi₂₋ₓAl(PO₄)₃(LTAP) (0≤x<4), Li_{1+x+y}AlₓTi₂₋ₓSiₓP_{3-y}O₁₂ (0<x<2, 0≤y<3), BaTiO₃, Pb(Zr,Ti)O₃(PZT), Pb₁₋ₓLaₓZr_{1-y}Ti_{y}O₃(PLZT) (0≤x<1, 0≤y<1), PB(Mg₃Nb_{2/3})O₃-PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂(0≤x≤1, 0≤y≤1), lithium lanthanum titanate (LiₓLa_{y}TiO₃, 0<x<2, 0<y<3), Li₂O, LiAlO₂, Li₂O-Al₂O₃-SiO₂-P₂O₅-TiO₂-GeO₂ ceramics, Garnet ceramics Li₃₊ₓLa₃M₂O₁₂ (wherein M=Te, Nb, or Zr; x may be an integer of 1 to 10), or a mixture thereof.

The solid electrolyte may further include, e.g., a halide solid electrolyte. The halide solid electrolyte may include a halogen element as a main component, meaning that a ratio of the halide element to all elements constituting the solid electrolyte may be, e.g., about 50 mol % or more, about 70 mol % or more, about 90 mol % or more, or about 100 mol %. As an example, the halide solid electrolyte may not include sulfur element.

The halide solid electrolyte may include a lithium element, a metal element other than lithium, and a halogen element. The metal element other than lithium may include, e.g., Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof. The halogen element may be, e.g., F, Cl, Br, I, or a combination thereof, and, e.g., it may be Cl, Br, or a combination thereof. The halide solid electrolyte may be, e.g., represented by LiₐM₁X₆ (M may be Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof, X may be F, Cl, Br, I, or a combination thereof, and 2≤a≤3). The halide solid electrolyte may include, e.g., Li₂ZrCl₆, Li_{2.7}Y_{0.7}Zr_{0.3}Cl₆, Li_{2.5} Y_{0.5}Zr_{0.5}Cl₆, Li_{2.5}In_{0.5}Zr_{0.5}Cl₆, Li₂In_{0.5}Zr_{0.5}Cl₆, Li₃ YBr₆, Li₃YCl₆, Li₃YBr₂Cl₄, Li₃YbCl₆, Li_{2.6}Hf_{0.4}Yb_{0.6}Cl₆, or a combination thereof.

The solid electrolyte may be in a form of particles, and the average particle diameter (D₅₀) may be less than or equal to about 5.0 μm, e.g., about 0.1 μm to about 5.0 μm, about 0.5 μm to about 5.0 μm, about 0.5 μm to about 4.0 μm, about 0.5 μm to about 3.0 μm, about 0.5 μm to about 2.0 μm, or about 0.5 μm to about 1.0 μm. Such a solid electrolyte may effectively penetrate between positive electrode active materials, and may have excellent contact with the positive electrode active material and connectivity between solid electrolyte particles.

Based on the total 100 wt % of the positive electrode active material layer, the solid electrolyte may be included in an amount of about 0.1 wt % to about 35 wt %, e.g., about 1 wt % to about 35 wt %, about 5 wt % to about 30 wt %, about 8 wt % to about 25 wt %, or about 10 wt % to about 20 wt %. Additionally, based on a total weight of the positive electrode active material and solid electrolyte in the positive electrode active material layer, about 65 wt % to about 99 wt % of the positive electrode active material and about 1 wt % to about 35 wt % of the solid electrolyte may be included, and, e.g., about 80 wt % to about 90 wt % of the positive electrode active material and about 10 wt % to about 20 wt % of the solid electrolyte may be included. If the solid electrolyte is included in the positive electrode in the above ranges, the efficiency and cycle-life characteristics of the all-solid-state battery may be improved without reducing the capacity.

### Negative Electrode

In an implementation, the negative electrode for an all-solid-state rechargeable battery may be the same negative electrode as described for a lithium ion battery.

Or, as another example, the negative electrode for an all-solid-state rechargeable battery may be a precipitation-type negative electrode, unlike the aforementioned negative electrode. The precipitation-type negative electrode may not include a negative electrode active material during battery assembly, but may refer to a negative electrode in which lithium metal, etc. may precipitated or electrodeposited on the negative electrode during battery charging, thereby serving as a negative electrode active material.

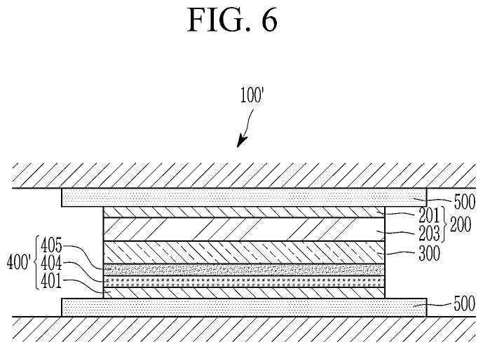

FIG. 6 is a schematic cross-sectional view of an all-solid-state rechargeable battery including a precipitation-type negative electrode. Referring to FIG. 6, the precipitation-type negative electrode 400′ may include a current collector 401 and a negative electrode coating layer 405 on the current collector. In an all-solid-state rechargeable battery having such a precipitation-type negative electrode 400′, initial charging begins in the absence of negative electrode active material, and during charging, high-density lithium metal may be precipitated or electrodeposited between the current collector 401 and the negative electrode coating layer 405 or on the negative electrode coating layer 405 to form a lithium metal layer 404, which may serve as a negative electrode active material. Accordingly, in an all-solid-state rechargeable battery that has been charged at least once, the precipitation-type negative electrode 400′ may include, e.g., a current collector 401, a lithium metal layer 404 on the current collector 401, and a negative electrode coating layer 405 on the metal layer 404. The lithium metal layer 404 may be referred to as a layer in which lithium metal, etc. may be precipitated during the charging process of the battery, and may be referred to as a metal layer, lithium layer, lithium electrodeposition layer, or negative electrode active material layer.

The negative electrode coating layer 405 may be referred to as a lithium electrodeposition inducing layer or a negative electrode catalyst layer, and may include a lithiophilic metal, a carbon material, or a combination thereof.

The lithiophilic metal may include, e.g., gold, platinum, palladium, silicon, silver, aluminum, bismuth, tin, zinc, or a combination thereof, and may be composed of one of these or various types of alloys. If the lithiophilic metal exists in particle form, its average particle diameter (D₅₀) may be less than or equal to about 4 μm, e.g., about 10nm to about 4 μm, about 10 nm to about 1 μm, or about 10 nm to about 600 nm. As an example, the lithiophilic metal may be in the form of nanoparticles with an average particle diameter of several to hundreds of nanometers.

The carbon material may be, e.g., crystalline carbon, amorphous carbon, or a combination thereof. The crystalline carbon may be, e.g., natural graphite, artificial graphite, mesophase carbon microbeads, or a combination thereof. The amorphous carbon may be, e.g., carbon black, activated carbon, acetylene black, Denka black, Ketjen black, or a combination thereof.

If the negative electrode coating layer 405 includes both a lithiophilic metal and a carbon material, the mixing ratio of the metal and the carbon material may be, e.g., a weight ratio of about 1:10 to about 2:1. In this case, precipitation of lithium metal may be effectively promoted and the characteristics of the all-solid-state rechargeable battery may be improved. In an implementation, the negative electrode coating layer 405 may include a carbon material on which a lithiophilic metal may be supported, or it may include a mixture of lithiophilic metal particles and carbon material particles.

In an implementation, the negative electrode coating layer 405 may include a lithiophilic metal and amorphous carbon, and in this case, it may effectively promote precipitation of lithium metal.

The negative electrode coating layer 405 may further include a binder, and the binder may be, e.g., a conductive binder. Additionally, the negative electrode coating layer 405 may further include general additives such as a filler, a dispersant, an ion conductive agent.

A thickness of the negative electrode coating layer 405 may be, e.g., about 100nm to about 20 μm, or about 500 nm to about 10 μm, or about 1 μm to about 5 μm.

The precipitation-type negative electrode 400′ may further include a thin film, e.g., on the surface of the current collector, that is, between the current collector and the negative electrode catalyst layer. The thin film may include an element capable of forming an alloy with lithium. The element capable of forming an alloy with lithium may be, e.g., gold, silver, zinc, tin, indium, silicon, aluminum, bismuth, or the like, which may be used alone or an alloy of more than one. The thin film may further planarize a precipitation shape of the lithium metal layer 404 and much improve characteristics of the all-solid-state rechargeable battery. The thin film may be formed, e.g., in a vacuum deposition method, a sputtering method, a plating method, and the like. The thin film may have, e.g., a thickness of about 1 nm to about 500 nm.

The lithium metal layer 404 may include a lithium metal or a lithium alloy. The lithium alloy may be, e.g., a Li—Al alloy, a Li—Sn alloy, a Li—In alloy, a Li—Ag alloy, a Li—Au alloy, a Li—Zn alloy, a Li—Ge alloy, or a Li—Si alloy.

A thickness of the lithium metal layer 404 may be about 1 μm to about 500 μm, about 1 μm to about 200 μm, about 1 μm to about 100 μm, or about 1 μm to about 50 μm. If the thickness of the lithium metal layer 404 is too thin, it may be difficult to perform the role of a lithium storage, and if it is too thick, the battery volume may increase and performance may deteriorate.

If applying such a precipitation-type negative electrode, the negative electrode coating layer 405 may serve to protect the lithium metal layer 404 and suppress the precipitation growth of lithium dendrite. Accordingly, short circuit and capacity degradation of the all-solid-state battery may be suppressed and cycle-life characteristics may be improved.

### Solid Electrolyte Layer

The solid electrolyte layer 300 may include a sulfide solid electrolyte, an oxide solid electrolyte, a halide solid electrolyte, and the like. The details of this may be the same as described in the positive electrode section, and thus they are omitted.

Meanwhile, an average particle diameter (D₅₀) of the solid electrolyte included in the solid electrolyte layer 300 may be larger than an average particle diameter (D₅₀) of the solid electrolyte included in the positive electrode 200. In this case, overall performance may be improved by maximizing the energy density of the all-solid-state rechargeable battery and increasing the mobility of lithium ions. In an implementation, the average particle diameter (D₅₀) of the solid electrolyte included in the positive electrode 200 may be about 0.1 μm to about 1.9 μm, or about 0.1 μm to about 1.0 μm, and the average particle diameter (D₅₀) of the solid electrolyte included in the solid electrolyte layer 300 may be about 2.0 μm to about 5.0 μm, or about 2.0 μm to about 4.0μm, or about 2.5 μm to about 3.5 μm. If the particle size is in the above ranges, the energy density of the all-solid-state rechargeable battery may be maximized and the transfer of lithium ions may be facilitated, thereby suppressing resistance and thus improving the overall performance of the all-solid-state rechargeable battery. Herein, the average particle diameter (D₅₀) of the solid electrolyte may be measured through a particle size analyzer using a laser diffraction method.

The solid electrolyte layer 300 may further include a binder in addition to the solid electrolyte. At this time, the binder may be a styrene butadiene rubber, polytetrafluoroethylene, polyvinylidene fluoride, polyethylene, an acrylate polymer, or a combination thereof, and any suitable binder may be used. The acrylate polymer may be, e.g., butyl acrylate, polyacrylate, polymethacrylate, or a combination thereof.

The solid electrolyte layer 300 may be formed by adding a solid electrolyte to a binder solution, coating it on a base film, and drying it. The solvent for the binder solution may be isobutyl isobutyrate, xylene, toluene, benzene, hexane, or a combination thereof. Since the solid electrolyte layer forming process is widely known in the art, detailed description will be omitted.

A thickness of the solid electrolyte layer 300 may be, e.g., about 10 μm to about 300 μm.

The solid electrolyte layer may further include an alkali metal salt, or an ionic liquid, or a conductive polymer.

The alkali metal salt may be, e.g., a lithium salt. A content of the lithium salt in the solid electrolyte layer may be greater than or equal to about 1 M, e.g., about 1 M to about 4 M. In this case, the lithium salt may improve ionic conductivity by improving lithium ion mobility of the solid electrolyte layer.

The lithium salt may include, e.g., LiPF₆, LiBF₄, LiSbF₆, LiAsF₆, LiClO₄, LiAlO₂, LiAlCl₄, LiPO₂F₂, LiCl, LiI, LiSCN, LiN(CN)₂, lithium bis(oxalato)borate (LiBOB), lithium difluoro(oxalato)borate (LiDFOB), lithium difluorobis(oxalato) phosphate (LiDFBP), lithium bis(trifluoromethanesulfonyl)imide (LiTFSI), lithium bis(fluoro)sulfonyl)imide (LiFSI), lithium bis(pentafluoroethanesulfonyl)imide (LiBETI), lithium trifluoromethane sulfonate, lithium tetrafluoroethane sulfonate, or a combination thereof.

In an implementation, the lithium salt may be an imide lithium salt such as LiTFSI, LiFSI, LiBETI, or a combination thereof. The imide lithium salt may maintain or improve ionic conductivity by appropriately maintaining chemical reactivity with the ionic liquid.

The ionic liquid may have a melting point below ambient temperature, so it may be in a liquid state at ambient temperature and may refer to a salt or ambient temperature molten salt composed of ions alone.

The ionic liquid may be a compound including at least one cation, e.g., a) ammonium, pyrrolidinium, pyridinium, pyrimidinium, imidazolium, piperidinium, pyrazolium, oxazolium, pyridazinium, phosphonium, sulfonium, triazolium, or a mixture thereof, and b) at least one anion, e.g., BF₄⁻, PF₆⁻, AsF₆⁻, SbF₆⁻, AlCl₄⁻, HSO₄⁻, ClO₄⁻, CH₃SO₃⁻, CF₃CO₂, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, and (CF₃SO₂)₂N⁻.

The ionic liquid may be, e.g., one or more selected from N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be about 0.1:99.9 to about 90:10, e.g., about 10:90 to about 90:10, about 20:80 to about 90:10, about 30:70 to about 90:10, about 40:60 to about 90:10, or about 50:50 to about 90:10. The solid electrolyte layer in the above ranges may maintain or improve ionic conductivity by improving the electrochemical contact area with the electrode. Accordingly, the energy density, discharge capacity, rate capability, etc. of the all-solid-state rechargeable battery may be improved.

An all-solid-state rechargeable battery may be a unit cell with a structure of positive electrode/solid electrolyte layer/negative electrode, a bicell with a structure of negative electrode/solid electrolyte layer/positive electrode/solid electrolyte layer/negative electrode, or a stacked battery in which the structure of the unit cell may be repeated.

The shape of the all-solid-state rechargeable battery may be, e.g., coin-shaped, button-shaped, sheet-shaped, stacked-shaped, cylindrical, flat, etc. Additionally, the all-solid-state rechargeable battery may also be applied to large batteries used in electric vehicles, etc. In an implementation, the all-solid-state rechargeable battery may also be used in hybrid vehicles such as plug-in hybrid electric vehicles (PHEV). In addition, it may be used in a field requiring a large amount of power storage, and may be used, e.g., in an electric bicycle or a power tool. In addition, the all-solid-state rechargeable battery may be used in various fields such as portable electronic devices.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### EXAMPLE 1

### (NCA Large (Radial)+NCAM Small, Dry)

### 1. Preparation of First Nickel Composite Hydroxide

A first nickel composite hydroxide (Ni_{0.945}Co_{0.04}Al_{0.015}(OH)₂), which was a

precursor of the first positive electrode active material, was synthesized through a co-precipitation method described later. A mixed solution of metal raw materials was prepared by dissolving nickel sulfate (NiSO₄·6H₂O), cobalt sulfate (CoSO₄·7H₂O), and sodium aluminum sulfate (NaAl(SO₄)₂·12H₂O) in distilled water as a solvent at a molar ratio of 94.5:4:1.5. In addition, aqueous ammonia (NH₄OH) and sodium hydroxide (NaOH) were prepared as a precipitant to form the complex.

[First Step: 2.5 kW/m³, NH₄OH 0.40 M, pH 10.5 to 11.5, and Reaction Time of 6 Hours]

First, aqueous ammonia having a concentration of 0.40 M was added in a reactor. While a metal raw material mixed solution and a complexing agent (NH₄OH) were added thereto respectively at 85 ml/min and 10 ml/min at 50° C. under a stirring power of 2.5 kW/m³, a reaction was started. While NaOH was added thereto to maintain pH, the reaction was performed for 6 hours. Core particles obtained as a reaction result had an average size of about 6.5 μm to 7.5 μm and then, a second step was performed as follows.

[Second Step: 2.0 kW/m³, NH₄OH 0.45 M, pH 10.5 to 11.5, and Reaction Time of 18 Hours

The metal raw material mixed solution and the complexing agent were added thereto respectively at 85 ml/min and 12 ml/min, while the reaction temperature was maintained at 50° C., so that a concentration of the complexing agent might be 0.45 M. While adding NaOH thereto in order to maintain pH, the reaction was performed for 18 hours. Herein, the reaction was performed by lowering the stirring power to 2.0 kW/m³, which was lower than that of the first step. Particles having a core and an intermediate layer produced from this reaction had an average size of 13.5 μm to 14 μm, and then, a third step was performed as follows.

[Third Step: 1.5 kW/m³, NH₄OH 0.45 M, pH 10.5 to 11.5, and Reaction Time of 14 Hours]

While maintaining the reaction temperature of 50° C., the input rate of the metal raw material mixed solution and the complexing agent and the concentration of the complexing agent were the same as in second step. While adding NaOH thereto in order to maintain pH, the reaction was performed for 14 hours. At this time, the stirring power was lowered to 1.5 kW/m³, which was lower than the second step, and the reaction proceeds. After washing the obtained product, hot air drying was performed at about 150° C. for 24 hours to obtain a first nickel composite hydroxide (Ni_{0.945}Co_{0.04}Al_{0.015}(OH)₂).

### 2. Preparation of Second Nickel Composite Hydroxide

A second nickel composite hydroxide (Ni_{0.94}Co_{0.04}Mn_{0.02}(OH)₂), which was a precursor of the second positive electrode active material, was synthesized through a co-precipitation method described later. A mixed solution of metal raw materials was prepared by dissolving nickel sulfate (NiSO₄·6H₂O), cobalt sulfate (CoSO₄·7H₂O), and manganese sulfate (MnSO₄·H₂O) in distilled water as a solvent at a molar ratio of 94:4:2. To form the complex, aqueous ammonia (NH₄OH) and sodium hydroxide (NaOH) were prepared as precipitants.

First, aqueous ammonia with a concentration of 0.25 M was added to the reactor, and the metal raw material mixed solution and complexing agent were added at a rate of 142 ml/min and 34 ml/min, respectively, at a stirring power of 3.0 kW/m³ and a reaction temperature of 50° C. The reaction was carried out for 30 hours while adding NaOH to maintain the pH. The reaction was completed when the average size of the obtained particles reached about 4 μm. After washing the obtained result, it was dried with hot air at about 150° C. for 24 hours to prepare a second nickel composite hydroxide (Ni_{0.94}Co0.04Mn_{0.02}(OH)₂).

3. Preparation of Positive Electrode Active Material

80 wt % of the first nickel composite hydroxide (Ni_{0.945}Co_{0.04}Al_{0.015}(OH)₂) and 20 wt % of the second nickel composite hydroxide (Ni_{0.94}Co_{0.04}Mn_{0.02}(OH)₂) were mixed, where LiOH was mixed so that lithium was 100 parts by mole based on 100 parts by mole of the total metal. A preliminary positive electrode active material was prepared by performing a first heat treatment in which the temperature was raised to 700° C. for 8 hours under an oxygen atmosphere and the temperature was maintained for 7 hours.

The method of forming a buffer layer on the preliminary positive electrode active material was a dry coating method as follows. The coating was performed by mixing the prepared preliminary positive electrode active material, zirconium oxide (ZrO₂), and anhydrous lithium hydroxide (LiOH) in a Henschel mixer. At this time, zirconium oxide was added so that zirconium was 0.25 parts by mole based on 100 parts by mole of metal excluding lithium in the preliminary positive electrode active material, and anhydrous lithium hydroxide was added so that lithium was 0.5 parts by mole.

During coating, the mixer was operated at low, medium, and high speeds to ensure even coating without layer separation, and heat treatment was performed at 460° C. for 15 hours in an oxygen atmosphere to prepare the final positive electrode active material (LiNi_{0.944}Co_{0.04}Al_{0.012}Mn_{0.004}O₂) coated with a buffer layer.

In the final positive electrode active material, the first positive electrode active material was confirmed to be in the form of secondary particles with an internal portion having an irregular porous structure and an external portion having a radially oriented structure as a result of SEM analysis of the cross section, and the average particle diameter (D₅₀) of the secondary particles measured through SEM images was confirmed to be about 14 μm. The second positive electrode active material was confirmed to be in the form of secondary particles in which a plurality of primary particles were agglomerated, and the average particle diameter (D₅₀) of the secondary particles measured through SEM images was confirmed to be about 3.5 μm.

The composition analysis of the second positive electrode active material is described in Evaluation Example 3, and the analysis of the crystalline phase of the coating layer of each of the first and second positive electrode active materials is described in Evaluation Example 4.

### 4. Manufacture of Positive Electrode

84.9 wt % of positive electrode active material coated with a buffer layer, 13.61 wt % of argyrodite-type solid electrolyte of Li₆PS₅Cl (D₅₀=1 μm), 1 wt % of PVdF binder, 0.35 wt % of carbon nanotube conductive material, and 0.14 wt % of hydrogenated nitrile butadiene rubber (HNBR) were added to an isobutyl isobutyrate (IBIB) solvent and mixed to prepare a positive electrode composition. This was applied to the positive electrode current collector, dried, and rolled (hydrostatic press (WIP), 500 Mpa, 85° C., 30 min) to prepare a positive electrode.

5. Manufacturing of All-solid-state Rechargeable Battery Cell

A negative electrode coating layer composition was prepared by mixing carbon black having a primary particle diameter of about 30 nm and silver (Ag) having an average particle diameter (D₅₀) of about 60 nm in a weight ratio of 3:1 to prepare an Ag/C composite and adding 0.25 g of the composite to 2 g of an NMP solution including 7 wt % of a polyvinylidene fluoride binder and then, mixing them. The negative electrode coating layer composition was coated on a negative current collector and dried to prepare a precipitation-type negative electrode having a negative electrode coating layer on the current collector.

A composition for a solid electrolyte layer was prepared by adding an argyrodite-type solid electrolyte (D₅₀=3 μm) of Li₆PS₅Cl to an IBIB solvent including an acryl binder. In the composition, 98.5 wt % of the solid electrolyte and 1.5 wt % of the binder were included. The composition was coated on a releasing film and then, dried at ambient temperature to form a solid electrolyte layer.

After cutting the prepared positive electrode, negative electrode, and solid electrolyte layer, the solid electrolyte layer was stacked on the positive electrode, and the negative electrode was stacked thereon. This stack was sealed in the form of a pouch and then, hydrostatically pressed at a high temperature of 80° C. under 500 MPa for 30 minutes to manufacture an all-solid-state rechargeable battery cell.

### Comparative Example 1

### (NCA Large (Radial)+NCM Small, Dry)

### 1. Preparation of First Lithium Nickel Composite Oxide

The first nickel composite hydroxide of Example 1 was mixed with LiOH, which was used to have 100 parts by mole of lithium based on 100 parts by mole of total metals of the first nickel composite hydroxide, and then, heated to 700° C. under an oxygen atmosphere for 8 hours and maintained at the same temperature for 7 hours to prepare a first lithium nickel composite oxide (LiNi_{0.945}Co_{0.04}Al_{0.015}O₂).

This prepared first lithium nickel composite oxide was confirmed to be in the form of secondary particles, which had an internal portion with an irregular porous structure and an external portion with a radially oriented structure, wherein the secondary particles had an average particle diameter (D₅₀) of about 14 μm, which was measured through a particle size distribution meter using laser diffraction.

### 2. Preparation of Second Lithium Nickel Composite Oxide

The second nickel composite hydroxide of Example 1 was mixed with LiOH, which was used to have 100 parts by mole of lithium based on 100 parts by mole of total metals of the second nickel composite hydroxide, and then, heat-treated at 700° C. under an oxygen atmosphere for 10 hours to obtain second lithium nickel composite oxide (LiNi_{0.94}Co_{0.04}Mn_{0.02}O₂).

This prepared second lithium nickel composite oxide was confirmed to be in the form of secondary particles, in which a plurality of primary particles were agglomerated, wherein the secondary particles had an average particle diameter (D₅₀) of about 3.5 μm, which was measured through a particle size distribution meter using laser diffraction.

### 3. Buffer Layer Coating of Positive Electrode Active Material

On the positive electrode active materials, a buffer layer was formed by adopting the following dry coating method. The prepared first lithium nickel composite oxide and the second lithium nickel composite oxide were mixed in a Hansel mixer at a weight ratio of 8:2. Herein, zirconium oxide (ZrO₂) was added, so that zirconium was 0.25 parts by mole based on 100 parts by mole of total metals excluding lithium of the first lithium nickel composite oxide and the second lithium nickel composite oxide, and anhydrous lithium hydroxide was added, so that lithium was 0.5 parts by mole based on 100 parts by mole of the total metals excluding lithium of the first lithium nickel composite oxide and the second lithium nickel composite oxide. During the coating, the mixer was operated at low, medium, and high speeds to ensure even coating without layer separation, and a heat treatment was performed at 500° C. for 15 hours under an oxygen atmosphere to prepare the final positive electrode active material (LiNi_{0.944}Co_{0.04}Al_{0.012}Mn_{0.004}O₂) coated with a buffer layer.

Except for the above, a positive electrode and an all-solid-state rechargeable battery were manufactured substantially in the same manner as in Example 1.

### Comparative Example 2

### (NCA Large (Radial)+NCA Small, Dry)

A third nickel composite hydroxide (Ni_{0.945}Co_{0.04}Al_{0.015}(OH)₂) in the form of secondary particles, in which a plurality of primary particles were agglomerated and which had an average particle diameter (D₅₀) of about 4 μm, was prepared by using the metal raw material mixed solution used in the method of preparing the first nickel composite hydroxide of Example 1 and performing a co-precipitation reaction in substantially the same method as the method of preparing the second nickel composite hydroxide.

A positive electrode active material, a positive electrode, and an all-solid-state rechargeable battery cell were manufactured substantially in the same method as Comparative Example 1 except that the third nickel composite hydroxide was used instead of the second nickel composite hydroxide.

### Comparative Example 3

### (NCA Large (Non-radial)+NCA Small, Dry)

The metal raw material mixed solution used in the method of preparing the first nickel composite hydroxide of Example 1 was added to a continuous reactor, while adding an aqueous ammonia dilution, and a sodium hydroxide aqueous solution was added thereto to maintain pH inside the reactor. After slowly proceeding a reaction for about 80 hours, when the reaction was stabilized, a product overflowing therefrom was collected. The collected product was washed and dried at about 150° C. for 24 hours to prepare fourth nickel composite hydroxide (Ni_{0.945}Co_{0.04}Al_{0.015}(OH)₂) in the form of secondary particles, in which primary particles were not radially oriented and which had an average particle diameter (D₅₀) of about 15 μm.

A positive electrode active material, a positive electrode, and an all-solid-state rechargeable battery cell were manufactured substantially in the same manner in Comparative Example 1 except that the fourth nickel composite hydroxide was used instead of the first nickel composite hydroxide.

### Comparative Example 4

### (NCA Large (Radial)+NCM Small, Without Buffer Layer Coating)

A positive electrode active material, a positive electrode, and an all-solid-state rechargeable battery cell were manufactured substantially in the same manner in Comparative Example 1 except that the positive electrode active material buffer layer was not coated.

### Comparative Example 5

### (NCA Large (Radial)+NCM Small, Wet Buffer Layer Coating)

A positive electrode active material, a positive electrode, and an all-solid-state rechargeable battery cell were manufactured substantially in the same manner as in Comparative Example 1 except that a buffer layer was coated on the positive electrode active material in the following wet coating method.

After mixing dehydrated 2-propanol, a methanol solution including 10% of lithium methoxide, and zirconium isopropoxide in a molar ratio of 200:2:1, the first lithium nickel composite oxide and the second lithium nickel composite oxide in a weight ratio of 8:2 were added thereto and then, dispersed therein. Herein, zirconium was designed to be included in an amount of 0.25 parts by mole based on 100 parts by mole of total metals excluding lithium in the composite oxides. In order to prevent agglomeration of the positive electrode active material particles, the solvents were evaporated at 50° C. under vacuum, while being irradiated with ultrasonic waves. A resulting material therefrom was filtered and heat-treated at 350° C. under an air atmosphere for 1 hour to obtain the positive electrode active material coated with a buffer layer including Li₂CO₃, LiOH, and ZrO₂.

For better understanding, the designs of the positive electrode active materials of Example 1 and Comparative Examples 1 to 5 are briefly shown in Table 1.

TABLE 1

| | Large | Small | Coating |
|---|---|---|---|
| | particles | particles | method |
| Example 1 | NCA Large | NCAM Small | dry |
| Comparative Example 1 | (Radial) | NCM Small | |
| Comparative Example 2 | | NCA Small | |
| Comparative Example 3 | NCA Large | | |
| | (Non-radial) | | |
| Comparative Example 4 | NCA Large | NCM Small | Without |
| | (Radial) | | buffer layer |
| Comparative Example 5 | NCA Large | | wet |
| | (Radial) | | |

### Evaluation Example 1

### Evaluation of Initial Charge/Discharge Capacity of All-Solid-State Rechargeable Battery Cells

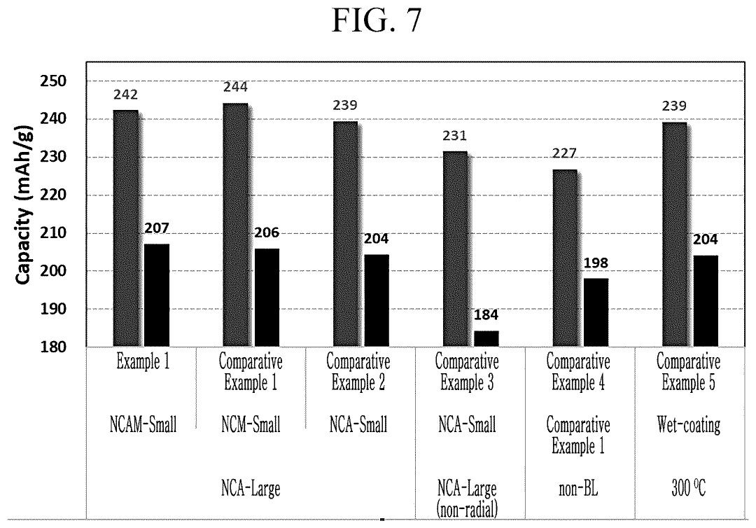

The all-solid-state rechargeable battery cells according to Example 1 and Comparative Examples 1 to 5 were constant current-charged to 4.25 V at 0.1 C and constant voltage-charged to 0.05 C to measure charge capacity and then, discharged to 2.5 V at 0.1 C to measure initial discharge capacity at 45° C., and then, a ratio of the discharge capacity to the charge capacity was calculated as efficiency, and the results are shown in FIG. 7 and Table 2.

TABLE 2

| | Charge | Discharge | |
|---|---|---|---|
| | capacity | capacity | Efficiency |
| | (mAh/g) | (mAh/g) | (%) |
| Example 1 | 242.3 | 207.2 | 85.5% |
| Comparative Example 1 | 244.2 | 205.9 | 84.3% |
| Comparative Example 2 | 239.4 | 204.2 | 85.3% |
| Comparative Example 3 | 231.5 | 184.2 | 79.6% |
| Comparative Example 4 | 226.7 | 198.0 | 87.3% |
| Comparative Example 5 | 239.2 | 204.2 | 85.4% |

Referring to FIG. 7 and Table 2, compared with Comparative Example 5 in which a buffer layer was formed by using an expensive metal alkoxide raw material in an organic solvent according to a conventional art, Example 1 and Comparative Examples 1 to 2, to which a dry coating method for securing easy mass production was applied, secured equivalent or greater charge/discharge capacity.

When checked in Evaluation Example 3, Example 1, in which large particles and small particles were simultaneously fired to make the large particles of Al move to the small particles and doped thereon, turned out to improve performance of the all-solid-state battery cell and to facilitate mass production of the positive electrode active material.

Comparative Example 3, in which non-radial but large particles of NCA were used and much increased internal resistance inside the active material, exhibited lower capacity than Comparative Example 4, in which a separate buffer layer was not coated.

### Evaluation Example 2

### Evaluation of Cycle-Life Characteristics of Rechargeable Battery Cells

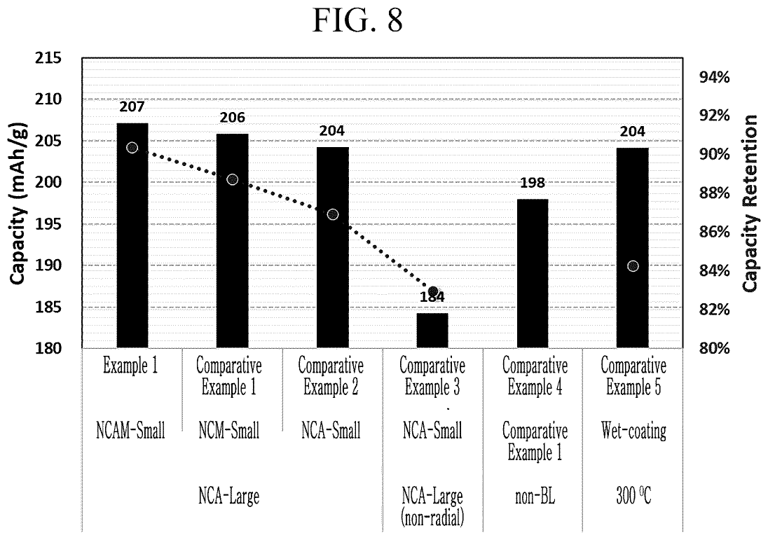

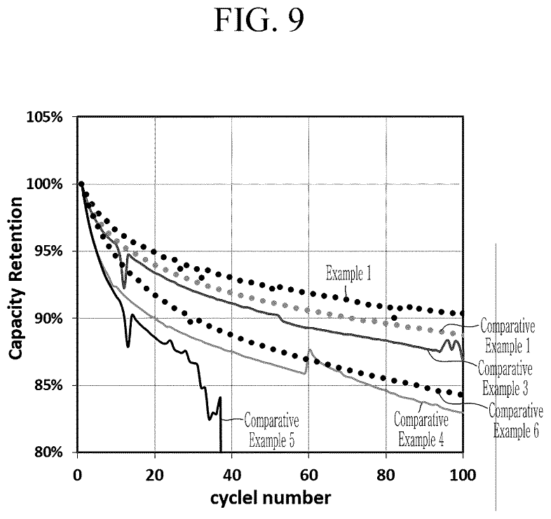

The all-solid-state rechargeable battery cells of Example 1 and Comparative Examples 1 to 5 were initially charged and discharged as in Evaluation Example 1 and then, 100 times repeatedly charged at 0.33 C and discharged at 0.33 C within a voltage range of 2.5 V to 4.25 V at 45° C. to evaluate cycle-life characteristics. In Table 3 and FIG. 8, a ratio of 100^{th} discharge capacity to initial discharge capacity was shown as capacity retention rate, and FIG. 9 shows a graph of a capacity change to the number of cycles.

TABLE 3

| | Initial discharge | 100th capacity |
|---|---|---|
| | capacity (mAh/g) | retention rate (%) |
| Example 1 | 207.2 | 90.4% |
| Comparative Example 1 | 205.9 | 88.7% |
| Comparative Example 2 | 204.2 | 86.9% |
| Comparative Example 3 | 184.2 | 83.0% |
| Comparative Example 4 | 198.0 | — |
| Comparative Example 5 | 204.2 | 84.3% |

Comparing Comparative Examples 1 with Comparative Example 5 using a different coating method to the same positive electrode active material, Comparative Example 1 using a dry coating method proposed in the present invention turned out to secure much more excellent initial discharge capacity and capacity retention rate during the cycle-life.

In addition, Example 1, in which a radial large particle NCA precursor and a small particle NCM precursor were simultaneously fired, resulting in small particles as NCAM, secured much more excellent initial discharge capacity and capacity retention rate during the cycle-life compared with Comparative Examples 1 to 5.

### Evaluation Example 3

### Evaluation of Small Particle Composition

In the final positive electrode active materials prepared in Example 1 and Comparative Example 1, large particles and small particles were separately prepared. The separation of the active materials was performed by using a turbo classifier (Nisshin Engineering Inc.) and nitrogen as a transfer gas. The separated small particles of Example 1 and Comparative Example 1 were measured with respect to each cobalt, aluminum, and manganese content through an ICP (Inductively Coupled Plasma) emission spectroscopic analysis, and the results are shown in Table 4.

TABLE 4

| mol % | Example 1 | Comparative Example 1 |
|---|---|---|
| Ni | 93.9 | 94.0 |
| Co | 3.9 | 4.1 |
| Al | 0.6 | — |
| Mn | 1.6 | 1.9 |

Referring to Table 4, Example 1 exhibited that 20 wt % of small particles NCM received AI from 80 wt % of large particles NCA and were doped with Al at a level of 0.6 mol %. The small particles of Example 1, which existed as NCAM with an NCM structure doped with Al, were effectively suppressed from a volume expansion according to charges and discharges, compared with the NCM small particles of Comparative Example 1 and the NCA small particles of Comparative Example 2, and thus improved structure stability of the positive electrode active material and thereby, improved capacity retention rate.

### Evaluation Example 4

### TEM Evaluation of Coating Layer

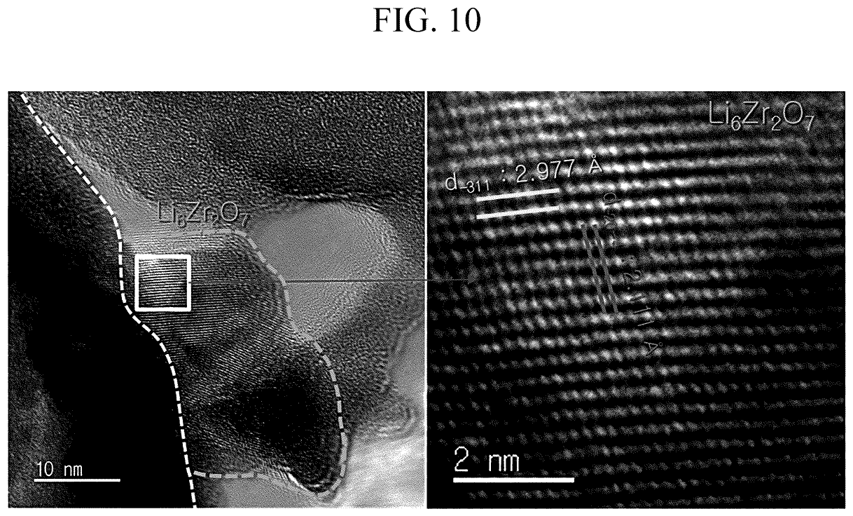

In order to analyze a crystalline phase of a coating layer, HRTEM and inverse-FFT analysis were performed on the cross-section of the large particles of Example 1. As a result of checking an atomic arrangement by selecting a relatively thick coating layer region as shown in the left drawing of FIG. 10, a Li₆ZrO₇ crystalline phase was confirmed as shown in the right drawing of FIG. 10.

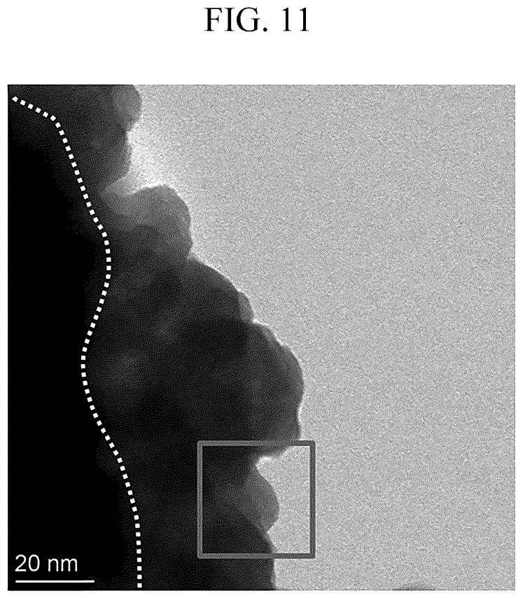

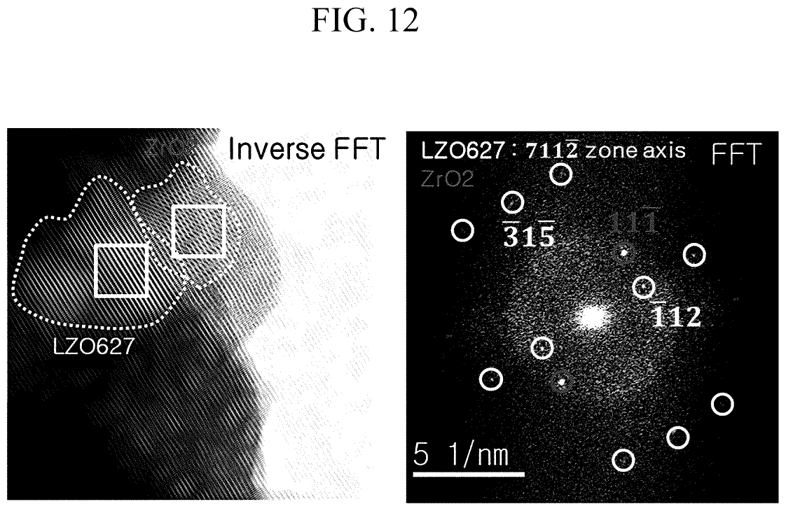

In addition, HRTEM and inverse-FFT analysis was performed on the cross-section of the small particles of Example 1. As a result of checking a crystal structure by selecting a relatively thick coating layer region, as shown in FIG. 11, a ZrO₂ crystalline phase, a Li₂ZrO₆ crystalline phase, and a Zr-containing amorphous portion were confirmed as shown in the left drawing of FIG. 12. As a result of analyzing a rotation pattern, as shown in the right drawing of FIG. 12, two ZrO₂ and Li₂ZrO₆ crystalline phases turned out to coexist.

By way of summation and review, various positive electrode active materials have been investigated to realize rechargeable lithium batteries for applications to the uses. Among them, lithium nickel oxide, lithium nickel manganese cobalt composite oxide, lithium nickel cobalt aluminum composite oxide, and lithium cobalt oxide are mainly used as positive electrode active materials.

Recently, high nickel positive electrode active materials have been widely used to increase capacity. In addition, in order to increase energy density, many positive electrode active materials are being developed that mix large and small particles of different particle sizes in an appropriate ratio. In this case, cracks may occur inside the particles during the charging and discharging process during long-term cycling. The cracks may cause a side reaction between the positive electrode active material and the electrolyte, which may result in gas generation, reduced safety, and depletion of the electrolyte, which also may reduce battery performance. Accordingly, there is a need for the development of a positive electrode active material that can exhibit high capacity and long cycle-life characteristics.

Furthermore, in recent years, there has been active development of all-solid-state rechargeable batteries using solid electrolytes instead of liquid electrolytes. However, a solid electrolyte, compared to the liquid electrolyte, may have low ionic conductivity, resistance on the interface with solid particles of a positive electrode active material and the like in a battery, deterioration of the ion conduction performance by formation of a depletion layer by solid-to-solid bonding, and the like. There is a need for the development of positive electrode active materials that can be used with these solid electrolytes, and the development of positive electrode active materials that can improve the overall performance, such as capacity characteristics and long cycle-life characteristics, of all-solid-state rechargeable batteries may also be necessary.

One or more embodiments may provide a positive electrode active material with high initial charge/discharge capacity, high efficiency, and excellent cycle-life characteristics, a method for preparing the same, and a positive electrode, a rechargeable lithium battery, and an all-solid-state rechargeable battery including the same.

The positive electrode active material according to some embodiments may have high capacity, high initial charge and discharge efficiency, and excellent cycle-life characteristics.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A positive electrode active material, comprising:
a first positive electrode active material including:
secondary particles including a lithium nickel-cobalt-aluminum composite oxide, wherein the secondary particles include an agglomeration of a plurality of primary particles and at least a portion of the plurality of primary particles are oriented radially, and
a coating layer on a surface of the secondary particles, the coating layer including ZrO₂ and Li₆Zr₂O₇; and
a second positive electrode active material including:
secondary particles including a lithium nickel-cobalt-aluminum-manganese composite oxide, wherein the secondary particles include an agglomeration of a plurality of primary particles, and
a coating layer on a surface of the secondary particles, the coating layer including ZrO₂ and Li₆Zr₂O₇,
wherein an average particle diameter of the secondary particles of the first positive electrode active material is larger than an average particle diameter of the secondary particles of the second positive electrode active material.

2. The positive electrode active material as claimed in claim 1, wherein:
the average particle diameter of the secondary particles of the first positive electrode active material is about 9 μm to about 25 μm, and the average particle diameter of the secondary particles of the second positive electrode active material is about 2 μm to about 8 μm.

3. The positive electrode active material as claimed in claim 1, wherein, based on a total weight of the first positive electrode active material and the second positive electrode active material, the first positive electrode active material is included in an amount of about 60 wt % to about 95 wt %, and the second positive electrode active material is included in an amount of about 5 wt % to about 40 wt %.

4. The positive electrode active material as claimed in claim 1, wherein the coating layer of the first positive electrode active material and the coating layer of the second positive electrode active material include a ZrO₂ crystalline phase, a Li₆Zr₂O₇ crystalline phase, and a Zr-containing amorphous region, respectively.

5. The positive electrode active material as claimed in claim 1, wherein the coating layer of the first positive electrode active material and the coating layer of the second positive electrode active material are in a form of a continuous film or in a form of an island.

6. The positive electrode active material as claimed in claim 1, wherein a thickness of each of the coating layer of the first positive electrode active material and the coating layer of the second positive electrode active material is about 5 nm to about 300 nm.

7. The positive electrode active material as claimed in claim 1, wherein a total Zr content of the coating layer of the first positive electrode active material and the coating layer of the second positive electrode active material is about 0.1 parts by mole to about 0.6 parts by mole, based on 100 parts by mole of total metal excluding lithium in the lithium nickel-cobalt-aluminum composite oxide of the first positive electrode active material and the lithium nickel-cobalt-aluminum-manganese composite oxide of the second positive electrode active material.

8. The positive electrode active material as claimed in claim 1, wherein a total Zr content of the coating layer of the first positive electrode active material and the coating layer of the second positive electrode active material is about 0.1 wt % to about 6 wt %, based on a total weight of the positive electrode active material.

9. The positive electrode active material as claimed in claim 1, wherein:
the lithium nickel-cobalt-aluminum composite oxide of the first positive electrode active material is represented by Chemical Formula 1:
[Chemical Formula 1]
Liₐ₁Niₓ₁Co_{y1}Al_{z1}M¹_{w1}O_{2-b1}X_{b1}
in Chemical Formula 1, 0.9≤a1≤1.2, 0.7≤x1<1, 0<y1<0.3, 0<z1<0.3, 0≤w1<0.3, 0.9≤x1+y1+z1+w1≤1.1, 0≤b1<0.1, M¹ is B, Ba, Ca, Ce, Cr, Cu, Fe, Mg, Mo, Nb, Si, Sr, Sn, Ti, V, W, or Zr, and X is F, P, or S.

10. The positive electrode active material as claimed in claim 1, wherein the average particle diameter of the plurality of primary particles constituting the secondary particles of the first positive electrode active material is less than about 200 nm.

11. The positive electrode active material as claimed in claim 1, wherein the secondary particle of the first positive electrode active material includes an internal portion having an irregular porous structure and an external portion having a radially oriented structure as a region surrounding the internal portion.

12. The positive electrode active material as claimed in claim 1, wherein:
at least a portion of the plurality of primary particles constituting the secondary particles in the first positive electrode active material have a plate shape, and
the secondary particles include open pores on the surface, and the open pores are formed by a space between plate-shaped primary particles oriented radially and the pores are connected from the surface of the secondary particle toward a center.

13. The positive electrode active material as claimed in claim 1, wherein:
the lithium nickel-cobalt-aluminum-manganese composite oxide of the second positive electrode active material is represented by Chemical Formula 2:
[Chemical Formula 2]
Liₐ₂Niₓ₂Co_{y2}Al_{z2}Mn_{w2}M²ᵥ₂O_{2-b2}X_{b2}
in Chemical Formula 2, 0.9≤a2≤1.2, 0.7≤x2<1, 0<y2<0.3,0<z2<0.3, 0<w2<0.3, 0≤v2<0.3, 0.95x2+y2+z2+w2+v2≤1.1, 0≤b2≤0.1, M² is B, Ba, Ca, Ce, Cr, Cu, Fe, Mg, Mo, Nb, Si, Sr, Sn, Ti, V, W, or Zr, and X is F, P, or S.

14. The positive electrode active material as claimed in claim 1, wherein:
the second positive electrode active material has a higher aluminum content in a surface layer of the secondary particles than the aluminum content in an internal portion of the secondary particles, and
the internal portion is a region from a center of the secondary particle to about 70 length % of a radius of the secondary particle, and the surface layer is a region surrounding the internal portion and is a region from an outermost surface of the secondary particle to a depth corresponding to about 30 length % of the radius of the secondary particle.

15. The positive electrode active material as claimed in claim 14, wherein:
an Al content in the surface layer of the secondary particles of the second positive electrode active material is about 0.2 at % to about 2.0 at %, based on 100 at % of total metal excluding lithium in the second positive electrode active material, and an Al content in the internal portion of the secondary particles of the second positive electrode active material is about 0 at % to about 0.6 at %, based on 100 at % of total metal excluding lithium in the second positive electrode active material.

16. The positive electrode active material as claimed in claim 14, wherein:
the surface layer of the secondary particles of the second positive electrode active material includes a high-concentration Al region and a low-concentration Al region,
an Al content in the high-concentration Al region is about 0.8 at % to about 2.0at %, based on 100 at % of total metal excluding lithium in the second positive electrode active material, and
an Al content in the low-concentration Al region is less than about 0.8 at %, based on 100 at % of total metal excluding lithium in the second positive electrode active material.

17. The positive electrode active material as claimed in claim 16, wherein a difference between the Al content in the high-concentration Al region and the Al content in the low-concentration Al region is about 0.3 at % to about 2.0 at %.

18. A method of preparing a positive electrode active material, the method comprising:
forming a first mixture by mixing a first positive electrode active material precursor including secondary particles including a nickel-cobalt-aluminum composite hydroxide, wherein the secondary particles are formed by agglomerating a plurality of primary particles and at least a portion of the primary particles is oriented radially, with a second positive electrode active material precursor including secondary particles including a nickel-cobalt-manganese composite hydroxide, wherein the secondary particles are formed by agglomerating a plurality of primary particles, and a lithium raw material;
performing a first heat treatment on the first mixture to obtain a preliminary positive electrode active material, wherein an average particle diameter of the first positive electrode active material precursor is larger than an average particle diameter of the second positive electrode active material precursor;
forming a second mixture by dry mixing the preliminary positive electrode active material and a zirconium raw material; and
performing a second heat treatment on the second mixture to obtain a final positive electrode active material.

19. The method as claimed in claim 18, wherein:
the nickel-cobalt-aluminum composite hydroxide of the first positive electrode active material precursor is represented by Chemical Formula 11, and
the nickel-cobalt-manganese composite hydroxide of the second positive electrode active material precursor is represented by Chemical Formula 12:
[Chemical Formula 11]
Niₓ₁₁Co_{y11}Al_{z11}M¹¹_{w11}(OH)2
in Chemical Formula 11, 0.7≤x11<1, 0<y11<0.3, 0<z11<0.3, 0≤w11<0.3, 0.9≤x11+y11+z11+w11≤1.1, and M¹¹ is B, Ba, Ca, Ce, Cr, Cu, Fe, Mg, Mo, Nb, Si, Sn, Sr, Ti, V, W, or Z,
[Chemical Formula 12]
Niₓ₁₂Co_{y12}Mn_{w12}M¹²ᵥ₁₂(OH)₂
in Chemical Formula 12, 0.7≤x12<1, 0<y12<0.3, 0<w12<0.3, 0≤v12<0.3, 0.9≤x12+y12+w12+v12≤1.1, and M¹² is B, Ba, Ca, Ce, Cr, Cu, Fe, Mg, Mo, Nb, Si, Sr, Sn, Ti, V, W, or Zr.

20. The method as claimed in claim 18, wherein:
an average particle diameter of the secondary particles of the first positive electrode active material precursor is about 9 μm to about 25 μm, and an average particle diameter of the secondary particles of the second positive electrode active material precursor is about 2 μm to about 8 μm.

21. The method as claimed in claim 18, wherein a mixing weight ratio of the first positive electrode active material precursor and the second positive electrode active material precursor is about 60:40 to about 95:5.

22. The method as claimed in claim 18, wherein the first heat treatment is performed at about 600° C. to about 1,000° C.

23. The method as claimed in claim 18, wherein the zirconium raw material is mixed in an amount of about 0.1 parts by mole to about 0.6 parts by mole based on 100 parts by mole of total metal excluding lithium in the preliminary active material.

24. The method as claimed in claim 18, wherein the zirconium raw material includes a plurality of particles including zirconium oxide, and an average particle diameter (D₅₀) of the plurality of particles is about 10 nm to about 500 nm.

25. The method as claimed in claim 18, wherein the second heat treatment is performed under an oxygen atmosphere at a temperature range of about 420° C. to about 580° C. for about 5 hours to about 25 hours.

26. The method as claimed in claim 18, wherein the lithium raw material is additionally mixed in the second mixture in an amount greater than about 1 part by mole and less than or equal to about 4 parts by mole based on 1 part by mole of the zirconium raw material.

27. A positive electrode comprising the positive electrode active material as claimed in claim 1.

28. The positive electrode as claimed in claim 27, wherein the positive electrode further includes a sulfide solid electrolyte.

29. A rechargeable lithium battery, comprising:
the positive electrode as claimed in claim 27;
a negative electrode;
a separator between the positive electrode and the negative electrode; and
a non-aqueous electrolyte.

30. An all-solid-state rechargeable battery, comprising:
the positive electrode as claimed in claim 27;
a negative electrode; and
a solid electrolyte layer between the positive electrode and the negative electrode.
